(19) United States
(12) Patent Application Publication
(10) Pub. No.: US 2014/0011177 A1
(43) Pub. Date: Jan. 9, 2014

(54) EXAMINATION CONDUCTING SUPPORT DEVICE, EXAMINATION CONDUCTING SUPPORT METHOD, AND RECORDING MEDIUM WITH EXAMINATION CONDUCTING SUPPORT METHOD PROGRAM STORED

(71) Applicant: FUJITSU LIMITED, Kawasaki (JP)

(72) Inventors: Hidehiko MAYUMI, Kawasaki (JP); Toshio TANAKA, Yokohama (JP); Takeaki KOBAYASHI, Yokohama (JP); Kenji SAKATA, Shinagawa (JP)

(73) Assignee: FUJITSU LIMITED, Kawasaki (JP)

(21) Appl. No.: 14/024,004

(22) Filed: Sep. 11, 2013

Related U.S. Application Data
(63) Continuation of application No. PCT/JP2011/056663, filed on Mar. 18, 2011.

(51) Int. Cl. G09B 7/00

(52) U.S. Cl. CPC G09B 7/00
USPC 434/336

(57) ABSTRACT

An examination conducting support device includes a processor. The processor obtains an answer for the examination questions sent from each of the plurality of examinee terminals, determines a correctness or incorrectness for the obtained answer and calculate an incorrect-answer ratio for each of the plurality of examination questions, extracts an examination question in which the number of obtained answers has reached a prescribed number as a determination target question, sends to an examinee terminal among the plurality of examinee terminals to which the determination target question has not yet been sent, the determination target question preferentially to other examination questions extracted from the question database and sent to the examinee terminal and decides a correctness or incorrectness of the presumption on the determination target question presumed to be an inappropriate question, on the basis of the incorrect-answer ratio for the determination target question after control is performed.

### CROSS-REFERENCE TO RELATED APPLICATION

This application is a continuation application of International Application PCT/JP2011/056663 filed on Mar. 18, 2011 and designated the U.S., the entire contents of which are incorporated herein by reference.

### FIELD

The embodiments discussed herein are related to a technology for supporting education.

### BACKGROUND

Questions given to a plurality of examinees in an examination sometimes include a question to which many examiners cause misunderstandings due to a failure to appropriately deliver a true intent of the question. Hereafter, such a question is called an “inappropriate question” or a “bad question”.

In a certificate examination system which provides examination questions to examinees, collects the answers for the questions, and provides result information of scoring and analysis, such a technology is known that, when an inappropriate question is found before starting the examination, the inappropriate question is changed to an appropriate question. Further, in a technology such as a game system, a technology is known that, when the correct-answer ratio of quiz questions given to a plurality of contestants gets out of the predetermined range, further quiz questions are blocked from being given.
Japanese Laid-open Patent Publication No. 2004-086670
Japanese Laid-open Patent Publication No. 2008-173366

The above mentioned inappropriate question might be detected by scoring, since the correct-answer ratio becomes low regardless of the level of understanding of the examinees. However, for detecting an inappropriate question by scoring, it is requested to collect a certain volume of answers from a plurality of the examinees, in order to accurately estimate the correct-answer ratio for each question.

Here, in an examination with a fixed question order for example, since a certain volume of answers may be collected within the examination time for questions earlier in the question order in the examination, the answer ratio may be estimated successfully within the examination time. Further, when an inappropriate question has been thus detected, it is possible to correct the detected inappropriate question. However, for questions later in the question order in the examination or for an examination with an unfixed question order which may be changed by the examinees, it may occur that the correct-answer ratio might not be estimated within the examination time with sufficient accuracy to detect an inappropriate question. In such cases, inappropriate questions are not detected and corrected within the examination time.

### SUMMARY

According to an aspect of the embodiments, an examination conducting support device includes a question database, a question sending unit, an answer obtaining unit, a calculating unit, an extracting unit, an inappropriate question presuming unit, a controlling unit, and an inappropriate question deciding unit. Here, a plurality of examination questions are stored in the question database. The question sending unit sends, to a plurality of examinee terminals operated by each of the plurality of examinees, the plurality of examination questions extracted from the question database, in a different order for each examinee terminal. The answer obtaining unit obtains answers for the examination questions sent from each of the plurality of examinee terminals. The calculating unit determines whether the answers obtained by the answer obtaining unit are correct or incorrect and calculates an incorrect-answer ratio for each of the plurality of examination questions which are stored in the question database. The extracting unit extracts, as a determination target in the plurality of examination questions stored in the question database, an examination question in which the number of obtained answers obtained by the answer obtaining unit has reached a prescribed number. The inappropriate question presuming unit presumes whether the determination target question is an inappropriate question, on the basis of the incorrect-answer ratio of the determination target question. The controlling unit controls the question sending unit, when the controlling unit presumes the determination target question to be an inappropriate question. The control is to send, to the examinee terminal to which the determination target question has not yet been sent in the above mentioned plurality of examinee terminals, the determination target question, preferentially to other examination questions which are extracted from the question database and sent to the examinee terminal. Then, the inappropriate question deciding unit decides whether the presumption on the determination target question presumed to be an inappropriate question is correct or incorrect, on the basis of the incorrect-answer ratio of the determination target question after the above mentioned control by the controlling unit.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 illustrates a functional diagram of one example of an examination conducting support device.

FIG. 2 illustrates a functional diagram of one example of an examination conducting support system.

FIG. 3 illustrates an example of a hardware configuration of a computer.

FIG. 4A illustrates a data example of a teacher table (TBL).

FIG. 4B illustrates a data example of an examination management TBL.

FIG. 4C illustrates a data example of a student TBL.

FIG. 4D illustrates a data example of a question order management TBL.

FIG. 4E illustrates a data example of a question TBL.

FIGS. 4F and 4G illustrate a data example (No. 1) of a correct/incorrect management TBL.

FIG. 4H illustrates a data example of a bad-question determining index TBL.

FIG. 4I illustrates a data example of a bad-question determining index application management TBL.

FIG. 4J illustrates a data example of a replacement target student TBL.

FIG. 5 illustrates a flow chart which illustrates, in a diagram, a processing content of teacher terminal operation processing.

FIG. 6 illustrates a flow chart which illustrates, in a diagram, a processing content of student terminal operation processing.

FIG. 7 illustrates a flow chart which illustrates, in a diagram, a processing content of question order management processing.

FIG. 8 illustrates a flow chart which illustrates, in a diagram, a processing content of examination management processing.

FIG. 9 illustrates a flow chart which illustrates, in a diagram, a processing content of question sending processing.

FIG. 10 illustrates a flow chart which illustrates, in a diagram, a processing content of answer obtainment processing.

FIG. 11 illustrates a flow chart which illustrates, in a diagram, a processing content of correct/incorrect determination processing.

FIG. 12 illustrates a flow chart which illustrates, in a diagram, a processing content of bad-question determination processing.

FIG. 13 illustrates a flow chart which illustrates, in a diagram, a processing content of question replacement processing.

FIGS. 14A and 14B illustrate a data example (No. 2) of a correct/incorrect management TBL.

FIG. 15 illustrates a drawing (No. 1) which explains a replacement operation of examination questions by a question order management unit.

FIGS. 16A and 16B illustrate a data example (No. 3) of a correct/incorrect management TBL.

FIG. 17 illustrates a flow chart which illustrates, in a diagram, a processing content of report processing.

FIG. 18 illustrates a screenshot of a notice screen.

FIG. 19 illustrates a flow chart which illustrates, in a diagram, a processing content of question correction processing.

FIG. 20A illustrates a screenshot (No. 1) of a correction screen.

FIG. 20B illustrates a screenshot (No. 2) of a correction screen.

FIG. 21 illustrates a drawing (No. 2) which explains a replacement operation of examination questions by a question order management unit.

FIG. 22 illustrates a screenshot of a corrected-question-added question set screen.

### DESCRIPTION OF EMBODIMENTS

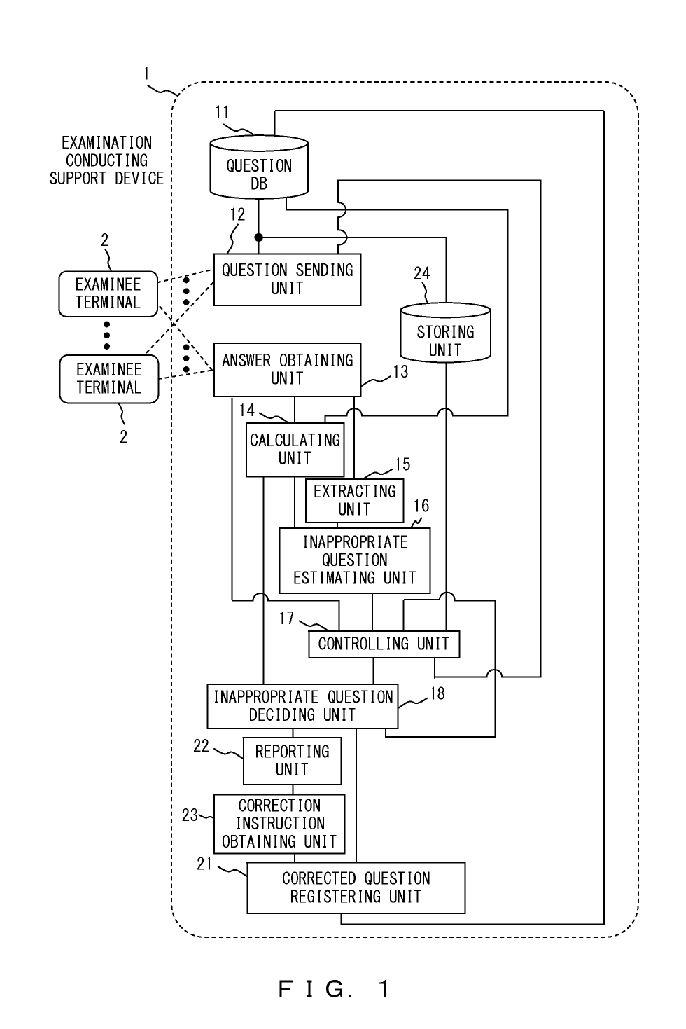

First, explanation is given for FIG. 1. FIG. 1 illustrates a functional diagram of one example of an examination conducting support device.

The examination conducting support device 1 includes a question database (DB) 11, a question sending unit 12, an answer obtaining unit 13, a calculating unit 14, an extracting unit 15, an inappropriate question presuming unit 16, a controlling unit 17, and an inappropriate question deciding unit 18. The examination conducting support device 1 may transmit and receive a variety of data via a wireless communication path or a wired communication path from among the plurality of examinee terminals 2 which are operated by the examinees.

A plurality of examination questions are stored in the question DB (question database) 11.

The question sending unit 12 sends, to a plurality of examinee terminals 2, a plurality of examination questions extracted from the question DB 11 in a different order for each examinee terminal 2.

The answer obtaining unit 13 obtains the answers for the above mentioned examination questions which are sent from each of the plurality of examinee terminals 2.

The calculating unit 14 determines whether the answer obtained from the answer obtaining unit 13 is correct or incorrect, and calculates the incorrect-answer ratio for each of the plurality of examination questions stored in the question DB 11.

The extracting unit 15 extracts an examination question which has reached a prescribed number of answers obtained by the answer obtaining unit 13, from the plurality of examination questions stored in the question DB 11, as the determination target question.

The inappropriate question presuming unit 16 presumes whether the determination target question is inappropriate on the basis of the incorrect-answer ratio of the determination target question.

The controlling unit 17 performs control of the question sending unit 12 when the inappropriate question presuming unit 16 has presumed that the determination target question is inappropriate. The control sends, to the examinee terminal 2 to which the determination target question has not yet been sent in the above mentioned plurality of examinee terminals, the determination target question preferentially over other examination questions which are extracted from the question DB 11 and sent to the examinee terminal 2.

The inappropriate question deciding unit 18 decides whether the presumption is correct or incorrect on the determination target question which was presumed to be inappropriate, on the basis of the incorrect-answer ratio on the determination target question after the above mentioned control by the controlling unit 17.

The examination conducting support device 1 collects the answers of each examinee by sending the examination questions in a different question order for each examinee terminal 2. Here, in the examination questions in which the number of answers has reached a prescribed number, an examination question with a significantly high incorrect-answer ratio is presumed to be inappropriate. Then, in order to decide whether the presumption is correct or incorrect on the determination target question which was presumed to be inappropriate, the determination target question is sent to the examinee terminal 2, to which the determination target question has not yet been sent, preferentially to other examination questions. Here, if the incorrect-answer ratio is still significantly high after the sending of the determination target question, it is decided that the determination target question is inappropriate. Thus, in the examination conducting support device 1, since the examination questions are sent in a different question order for each examinee terminal 2, the time for presuming or deciding an inappropriate question may be prevented from being extremely prolonged due to the question order.

Alternatively, the controlling unit 17 in the examination conducting support device 1 may control the question sending unit 12 as follows. The control here sends the determination target question to the predetermined number of examinee terminals 2 in descending order of the number of answers obtained by the answer obtaining unit 13 in the examinee terminals 2 to which the determination target question presumed to be inappropriate has not yet been sent.

It is considered that an examinee who is operating an examinee terminal 2 with a large number of answers obtained by the answer obtaining unit 13 is quick to be lead to the answers from the examination questions. Accordingly, when a determination target question presumed to be inappropriate is given to such an examinee, it is expected that the time for deciding whether the presumption is correct or incorrect may be further shortened.

The examination conducting support device 1 may further include a corrected question registering unit 21.

The corrected question registering unit 21 registers, in the question DB 11, the corrected question, which is the question obtained by correcting the determination target question decided to be inappropriate by the inappropriate question deciding unit 18.

When the corrected question registering unit 21 is included in the examination conducting support device 1, the question sending unit 12 sets the corrected question to be the question to be sent, instead of the determination question which was decided to be inappropriate, after the above mentioned corrected question is registered in the question DB 11.

With this configuration, since the corrected question instead of the determination target question is given to the examinee operating the examinee terminal 2 to which the determination target question which was decided to be inappropriate has not yet been sent, the examinee need not address the inappropriate question.

Alternatively, the controlling unit 17, after the above mentioned corrected question is registered in the question DB 11, may further cause the question sending unit 12 to send the corrected question to an examinee terminal 2 to which the determination target question which was decided to be inappropriate has already been sent, among the plurality of examinee terminals 2.

With the configuration, the corrected question may be given to an examinee who already answered the inappropriate question, as an additional question.

The examination conducting support device 1 may further include a reporting unit 22 and a correction instruction obtaining unit 23.

The reporting unit 22 reports a prescribed notice when the inappropriate question deciding unit 18 decides that the determination target question is inappropriate.

The correction instruction obtaining unit 23 obtains the instruction to correct the determination target question decided to be inappropriate, the instruction being input in the response to the above mentioned prescribed notice performed by the reporting unit 22.

When the reporting unit 22 and the correction instruction obtaining unit 23 are included in the examination conducting support device 1, the corrected question registering unit 21 registers, in the question DB 11, as the corrected question, the question obtained by correcting the determination target question decided to be inappropriate, following the instruction obtained by the correction instruction obtaining unit 23.

With this configuration, the corrected question instead of the determination target question is given to the examinee who is operating the examinee terminal 2 to which the determination target question which was decided to be inappropriate has not yet been sent. Accordingly, the examinee need not address the inappropriate question.

The examination conducting support device 1 may further include a storing unit 24.

The storing unit 24 stores the relationship between each of a plurality of examinee terminals 2 and the sending order of the examination questions sent to the examinee terminal 2 by the question sending unit 12.

When the storing unit 24 is included in the examination conducting support device 1, the controlling unit 17 is configured to specify the examinee terminal 2 to which the question sending unit 12 sends the determination question by the above mentioned control, on the basis of the above mentioned relationship stored in the storing unit 24.

With this configuration, the controlling unit 17 may specify an examinee terminal 2 to which the determination target question decided to be inappropriate has not yet been sent, or an examinee terminal 2 to which the determination target question decided to be in appropriate has already been sent.

In the examination conducting support device 1 of FIG. 1, the above mentioned examination questions and the correct answers for the examination questions may be stored, in is correlation with each examination question, in the question DB 11. In this case, the calculating unit 14 may determine whether the answers obtained by the answer obtaining unit 13 are correct or incorrect on the basis of the correct answers for the above mentioned examination questions stored in the question DB 11.

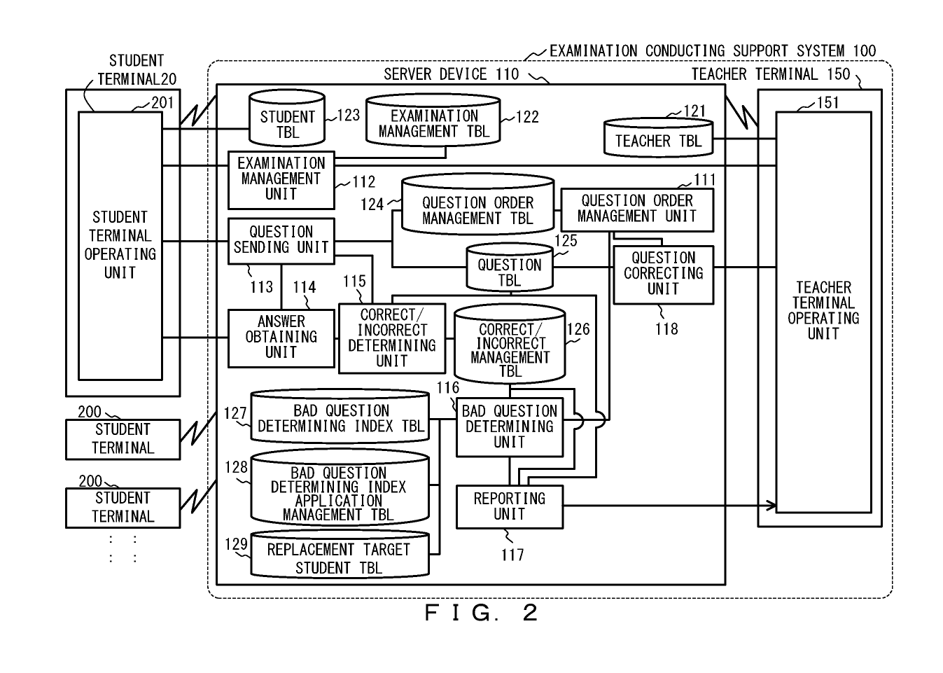

Next, explanation is given for FIG. 2. FIG. 2 illustrates a functional diagram of one example of an examination conducting support system.

In the following explanation, the example of using an examination conducting support system in conducting a drill exercise is given, wherein a teacher gives a plurality of examination questions to a plurality of students as part of a classwork, in a field of education, such as a classroom at school, and the like.

In FIG. 2, an examination conducting support system 100 is correlated to an examination conducting support device 1 in FIG. 1. The examination conducting support system 100 is configured to include a server device 110 and a teacher terminal 150, and the server device 110 and the teacher terminal 150 may transmit and receive a variety of data via a wireless communication path or a wired communication path. In addition, the server device 110 in the examination conducting support system 100 may also transmit and receive a variety of data via a wireless communication path or a wired communication path, from among a plurality of student terminals 200 operated by each student. The student terminal 200 is correlated to the examinee terminal 2 in FIG. 1.

The server device 110 includes each functional block of a question order management unit 111, an examination management unit 112, a question sending unit 113, an answer obtaining unit 114, a correct/incorrect determining unit 115, a bad-question determining unit 116, a reporting unit 117, and a question correcting unit 118 and a variety of data tables.

The question order management unit 111 manages question orders which differ for each student terminal 200 on a plurality of examination questions which are stored in a later mentioned question TBL (table) 125.

The examination management unit 112 manages the examination time for the exercise.

The question sending unit 113 sequentially sends, to each student terminal 200, a plurality of examination questions stored in the question TBL 125, under a control of the question order for each student terminal 200 by the question order management unit 111. The question sending unit 113 is correlated to the question sending unit 12 in the examination conducting support device 1 in FIG. 1.

The answer obtaining unit 114 obtains the answers for the examination questions sent from each student terminal 200 by the question sending unit 113. The answer obtaining unit 114 is correlated to the answer obtaining unit 13 in the examination conducting support device 1 in FIG. 1.

The correct/incorrect determining unit 115 determines whether the answers obtained by the answer obtaining unit 114 are correct or incorrect. The correct/incorrect determining unit 115 provides some functions that the calculating unit 14 has in the examination conducting support device 1 in FIG. 1.

The bad-question determining unit 116 presumes or decides whether, for each of the plurality of questions stored in the question TBL 125, the examination question is a bad question (that is, the above mentioned inappropriate question). The bad-question determining unit 116 provides some of the functions which the calculating unit 14 has, and the functions which each of the extracting unit 15, the inappropriate question presuming unit 16, the controlling unit 17, and the inappropriate question deciding unit 18 has.

The reporting unit 117 reports, to the teacher terminal 150, a prescribed notice which indicates that an examination question has been found which was decided to be a bad question by the bad-question determining unit 116. The reporting unit 117 is correlated to the reporting unit 22 in the examination conducting support device 1 in FIG. 1.

The question correcting unit 118 corrects the examination question decided to be a bad question in accordance with a correction instruction transmitted from the teacher terminal 150 in the response to the prescribed notice by the reporting unit 117. The question correcting unit 118 provides the functions which each of the correction instruction obtaining unit 23 and the corrected question registering unit 21 in the examination conducting support device 1 in FIG. 1 has.

The teacher terminal 150 includes a teacher terminal operating unit 151 as a functional block. The teacher terminal operating unit 151 obtains a variety of instructions from a teacher correlated to a variety of operational content by the teacher for the teacher terminal 150, and sends the instructions to the server device 110.

The student terminal 200 includes a student terminal operating unit 201 as a functional block. The student terminal operating unit 201 obtains a variety of instructions from a student correlated to a variety of operational content by the student for the student terminal 200, and sends the instructions to the server device 110.

Each of the server device 110, the teacher terminal 150, and the student terminal 200 in FIG. 2 includes the above mentioned types of functional blocks.

Any of the server device 110, the teacher terminal 150, and the student terminal 200 may be configured by using a computer with a standard configuration.

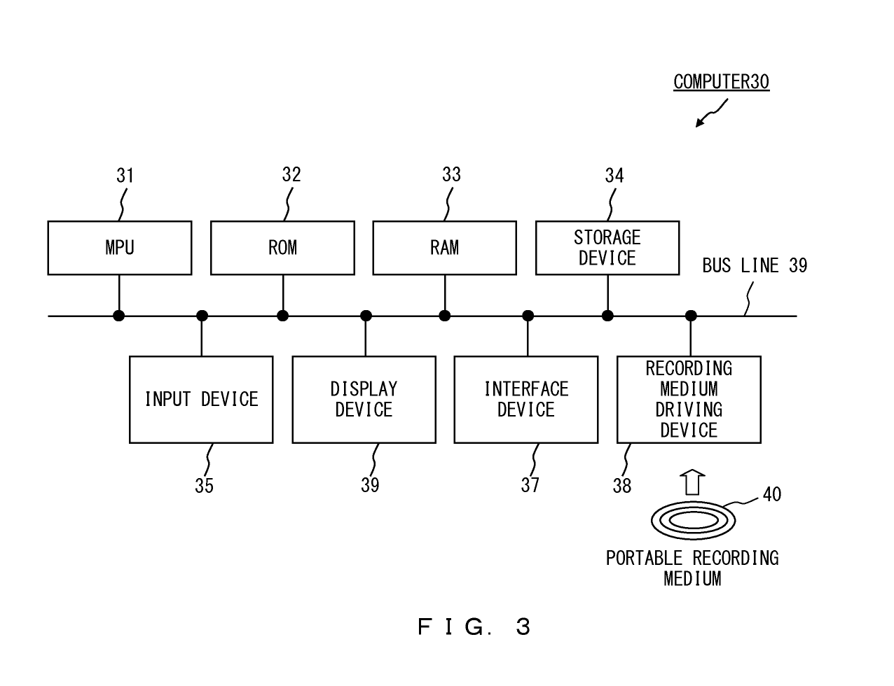

Here, explanation is given for FIG. 3. FIG. 3 illustrates an example of a hardware configuration of a computer.

The computer 30 includes an MPU 31, a ROM 32, a RAM 33, a storage device 34, an input device 35, a display device 36, an interface device 37, and a recording medium driving device 38. These components are connected via a bus line 39, and may mutually transmit and receive a variety of data under the control of the MPU 31.

The MPU (Micro Processing Unit) 31 is a processing unit which controls the operation of the entire computer 30.

The ROM (Read Only Memory) 32 is a read-only semiconductor memory in which a prescribed basic control program is pre-recorded. As the MPU 31 reads and executes the basic control program at the start of the computer 30, the operational control of each component of the computer 30 is enabled.

The RAM (Random Access Memory) 33 is any time writable and readable semiconductor memory used as a working storage area by the MPU 31, as needed, in executing a variety of control programs.

The storage device 34 is a device for storing a variety of control programs and data which are executed by the MPU 31. As the MPU 31 reads and executes the prescribed control program stored in the storage device 34, a variety of control processing is enabled. As the storage device 34, for example, a hard disc device, a flash SSD (Solid State Drive) device for which flash memory is employed as a storage medium, and the like, may be used.

The input device 35 includes a keyboard device and a mouse device, for example, and when it is operated by a user of the computer 30, the input device 35 obtains an input of each type of information from the user correlated to the operational content and sends the obtained input information to the MPU 31.

The display device 36 includes a liquid crystal display, for example, and it displays a variety of text and images in accordance with display data sent from the MPU 31.

As the input device 35 and the display device 36, a touch panel may be used which has a function of both the input device 35 and the display device 36 and which is configured to include a position input device such as a transparent touch pad, and the like, on a display screen of a display unit such as a liquid crystal panel and the like arranged therein.

The interface device 37 controls transmitting and receiving of a variety of data between a variety of pieces of equipment connected to the computer 30. For example, when the server device 110 and the teacher terminal 150 or the server device 110 and the student terminal 200 are connected by a wired communication path, a wired communication device for connecting the computer 30 to the wired communication path is provided as the interface device 37. In addition, for example, when the server device 110 and the teacher terminal 150 or the server device 110 and the student terminal 200 are connected by a wireless communication path, a wireless communication device for establishing a wireless communication path between them is provided as the interface device 37.

The recording medium driving device 38 is a device which reads a variety of control programs or data recorded in a portable recording medium 40. The MPU 31 may also perform a later mentioned variety of control processing, by reading and executing the prescribed control program recorded in the portable recording medium 40 via the recording medium driving device 38. The portable recording medium 40 includes, for example, CD-ROM (Compact Disc Read Only Memory), DVD-ROM (Digital Versatile Disc Read Only Memory), and flash memory including a connector of a USB (Universal Serial Bus) standard.

In order to make the computer 30 thus configured function as the server device 110, control programs are prepared for causing the MPU 31 to perform a later mentioned variety of control processing which is executed by the server device 110. The prepared control program is pre-recorded in the storage device 34 or the portable recording medium 40. In the control program, the storage device 34 is made to function as a storage place for a variety of data tables. Then, with a prescribed instruction to the MPU 31, the MPU 31 is made to read and execute the control program. With this, the computer 30 comes to function as the server device 110, since the computer 30 may provide the functions shared by each of the above mentioned functional blocks, which are included in the server 110.

Similarly, when making the computer 30 thus configured function as the teacher terminal 150, control programs are prepared for causing the MPU 31 to perform a later mentioned teacher terminal operation processing which is executed by the teacher terminal 150. The prepared control program is pre-recorded in the storage device 34 or the portable recording medium 40. Then, with a prescribed instruction to the MPU 31, the MPU 31 is made to read and execute the control program. With this, the computer 30 may provide the function which a teacher terminal operating unit 151 has.

Further, similarly, when making the computer 30 thus configured function as the student terminal 200, control programs are prepared for causing the MPU 31 to perform a later mentioned student terminal operation processing which is executed by the student terminal 200. The prepared control program is pre-recorded in the storage device 34 or the portable recording medium 40. Then, with a prescribed instruction to the MPU 31, the MPU 31 is made to read and execute the control program. With this, the computer 30 may provide the function which a student terminal operating unit 201 has.

Next, explanation is given for a data structure of a variety of data tables included in the server device 110 of FIG. 2. In a later mentioned variety of control processing, these data tables are referred to and updated, as needed.

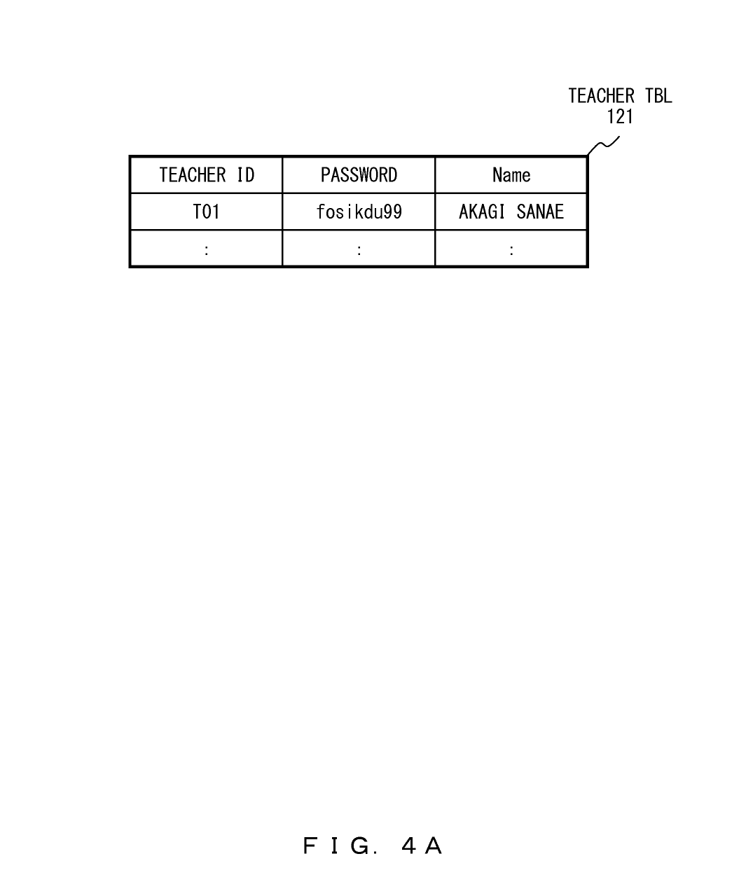

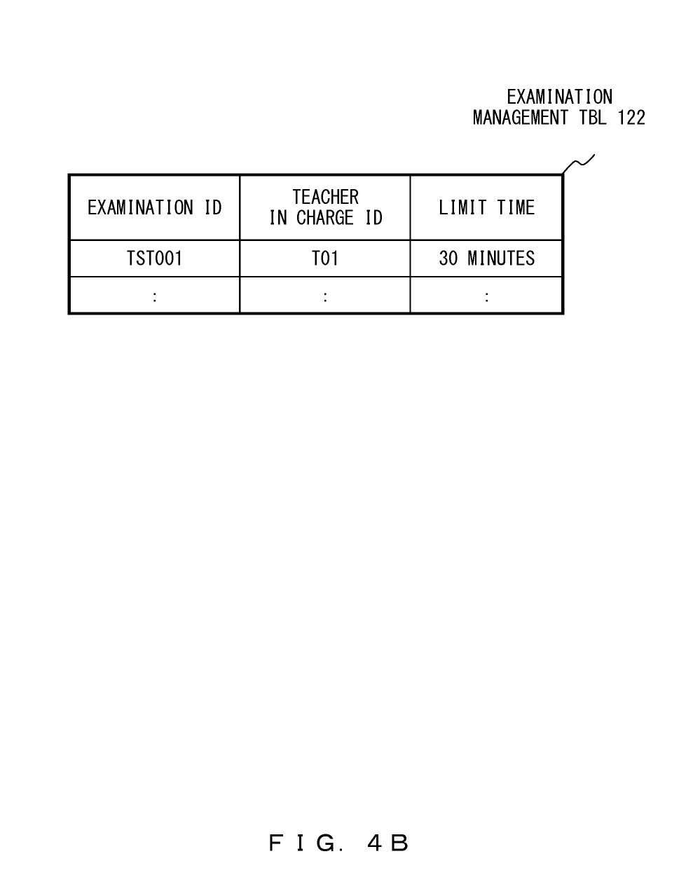

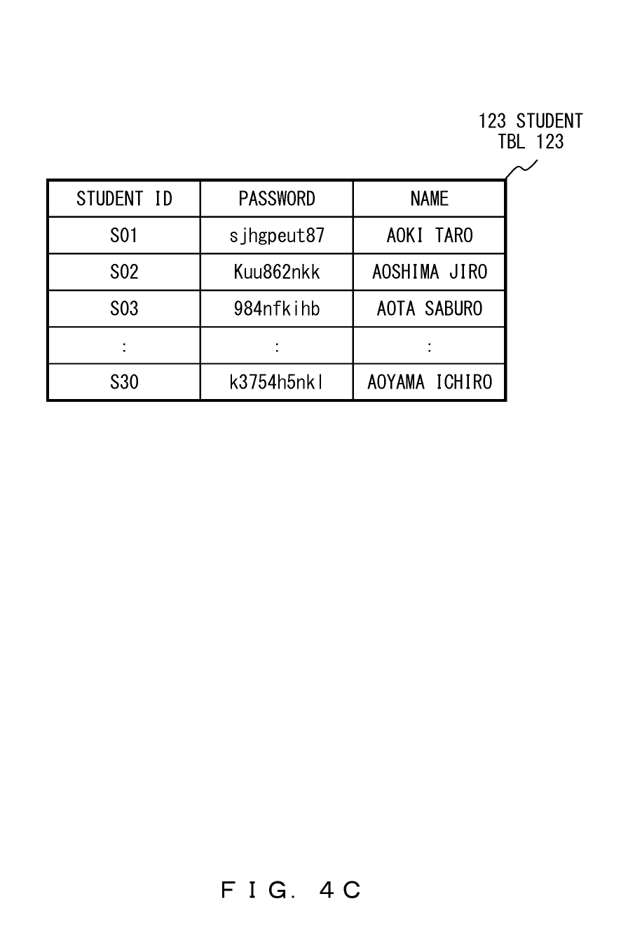

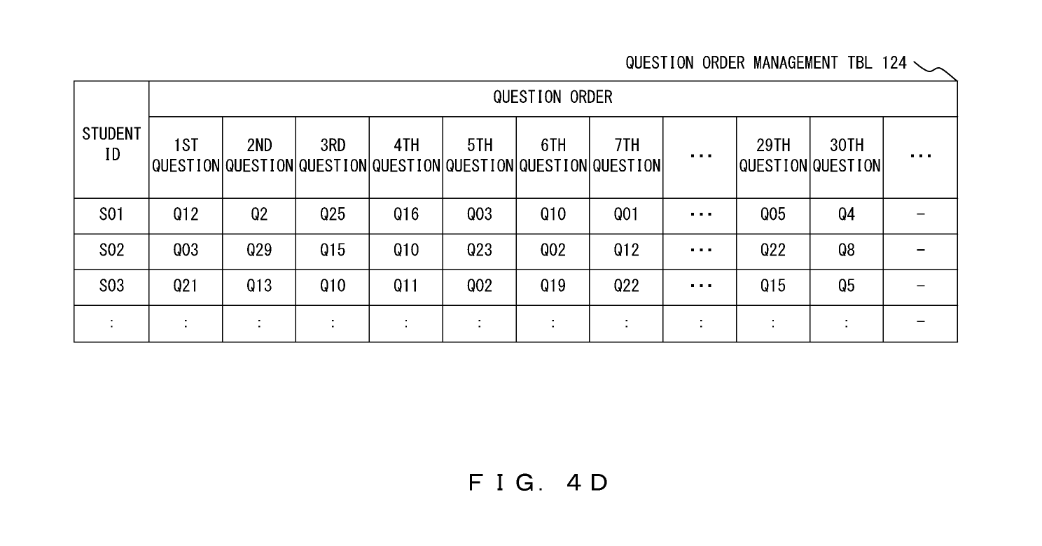

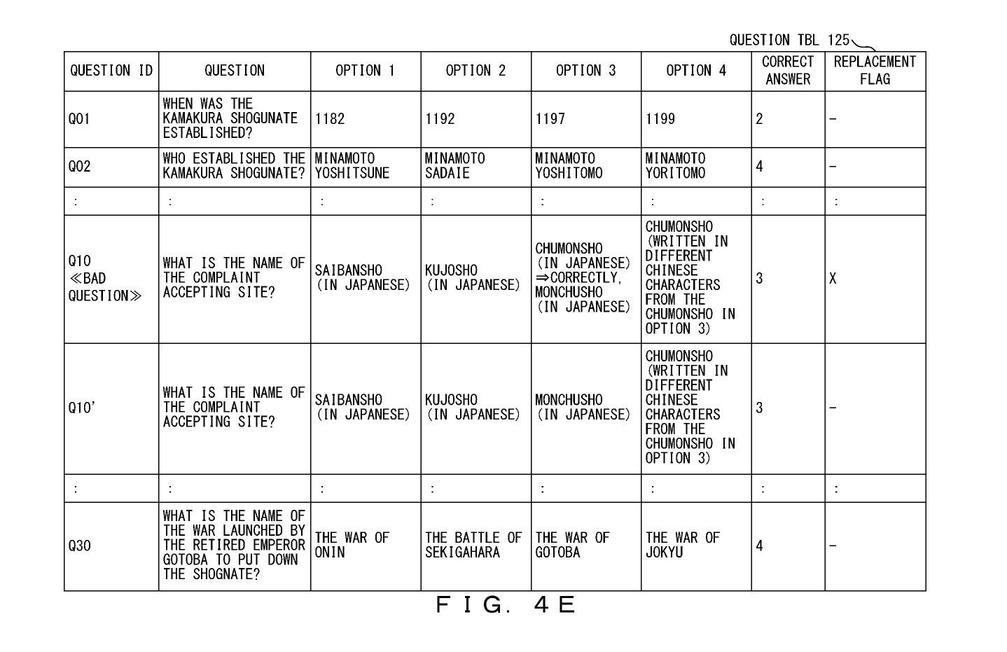

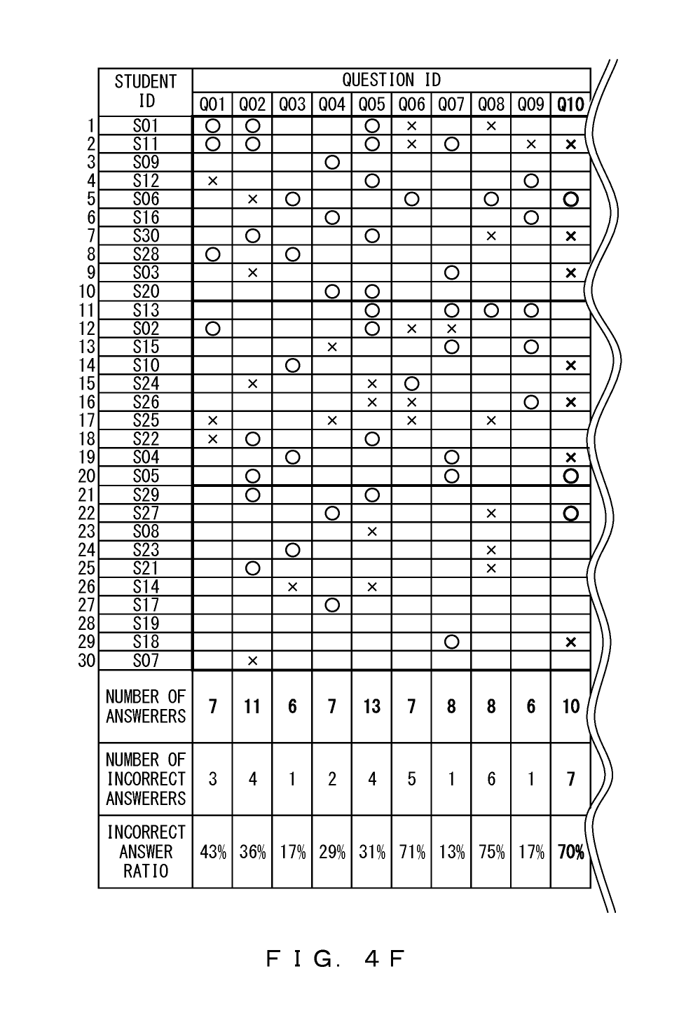

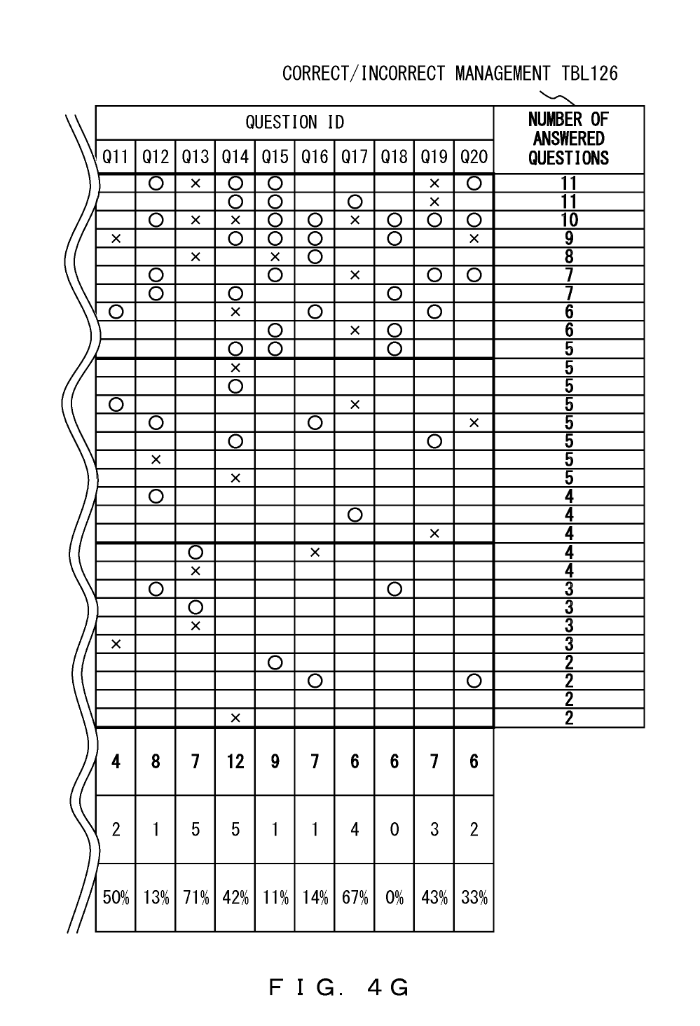

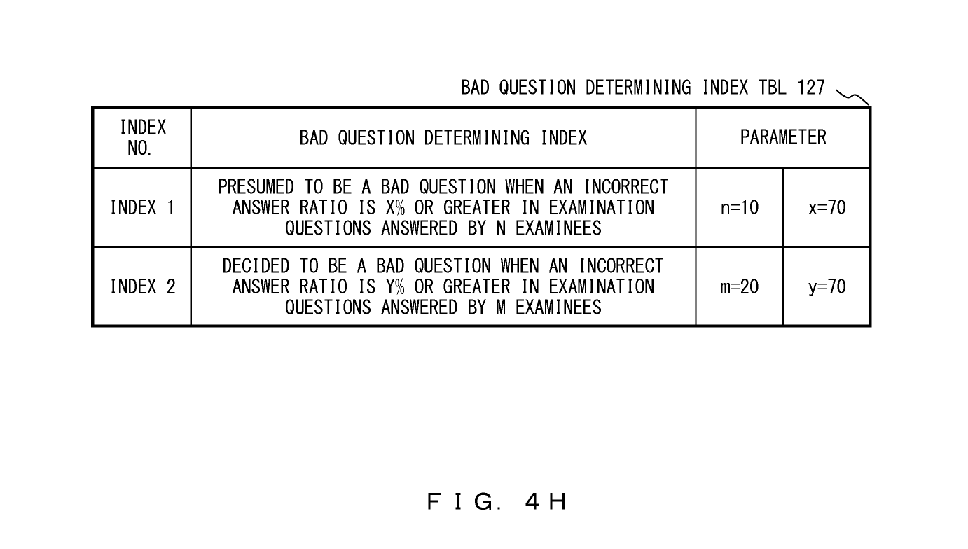

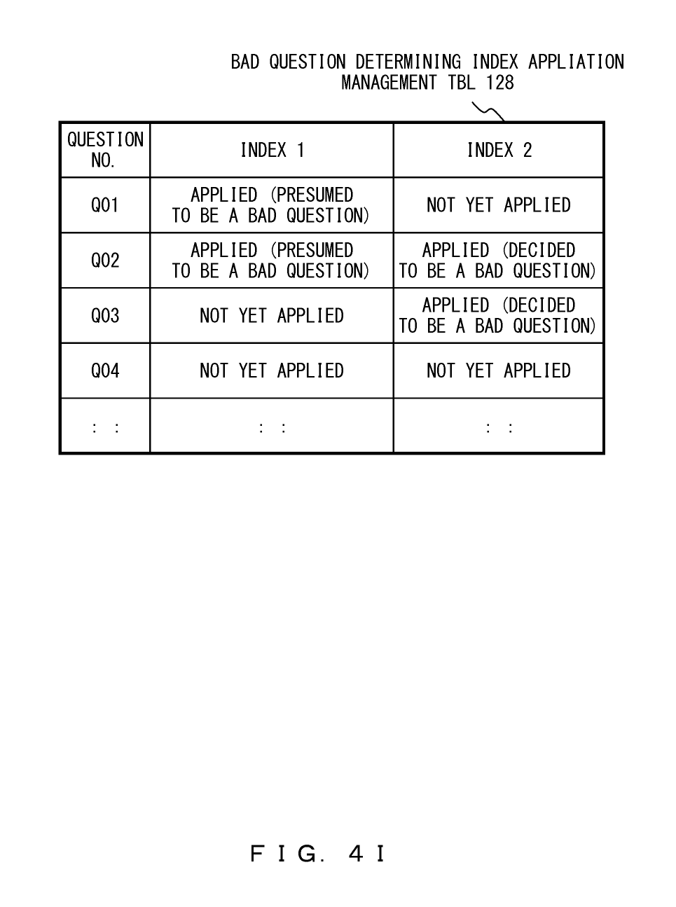

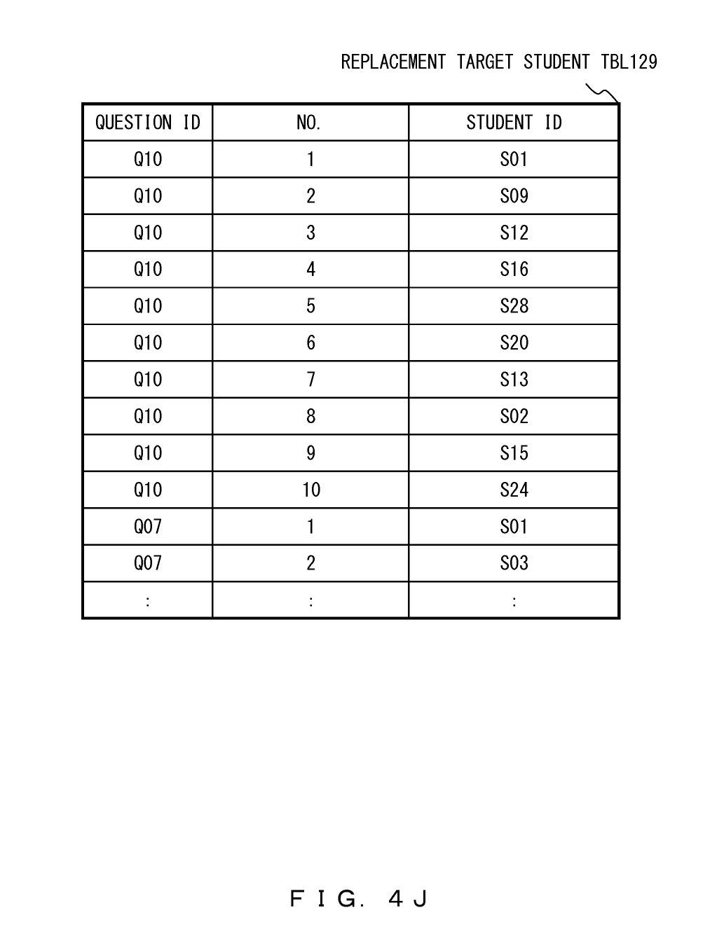

First, explanation is given for a teacher TBL 121. The teacher TBL 121 is the data table containing identification information of a teacher who is operating the teacher terminal 150. FIG. 4A illustrates a data example of a teacher TBL 121.

The teacher TBL 121 has a configuration in which each piece of data of a “teacher ID”, “password”, and “name” is correlated to each column. Here, the “teacher ID” is the identification information data separately assigned to the teacher who is operating the teacher terminal 150. The “password” is the data used for authenticating the teacher specified by the “teacher ID”, which is to be set by the teacher himself beforehand. The “name” is the data of the name of the teacher specified by the “teacher ID”.

Next, explanation is given for an examination control TBL 122. The examination control TBL 122 is the data table in which information on the content of the examination conducted as an exercise is stored. FIG. 4B illustrates a data example of an examination management TBL 122.

The examination control TBL 122 has a configuration in which each piece of data of an “examination ID”, “teacher in charge ID”, and “limit time” is correlated to each column. Here, the “examination ID” is the identification information data separately assigned to each examination to be conducted. The “teacher in charge ID” is the identification information data (that is, the above mentioned teacher ID) assigned to the teacher who conducts the examination specified by the “examination ID”. The “limit time” is the data of the examination time on the examination specified by the “examination ID”.

Next, explanation is given for a student TBL 123. The student TBL 123 is the data table in which identification information on each student who is operating the student terminal 200 is stored. FIG. 4C illustrates a data example of a student TBL 123.

The student TBL 123 has a configuration in which each piece of data of a “student ID”, “password”, and “name” is correlated to each column. Here, the “student ID” is the identification information data separately assigned to each student who is operating the student terminal 200. The “password” is the data used for authenticating the student specified by the “student ID”, which is to be set by the student himself beforehand. The “name” is the data of the name of the student specified by the “student ID”.

Next, explanation is given for a question order management TBL 124. The question order management TBL 124 is the data table used for controlling, for each student terminal 200, the question order of a plurality of examination questions stored in a later mentioned question TBL 125. The question TBL 125 is correlated to a storing unit 24 in the examination conducting support device 1 of FIG. 1. FIG. 4D illustrates a data example of a question order management TBL 124.

The question order management TBL 124 has a configuration in which each piece of data of a “student ID”, “1^{st} question”, “2^{nd} question”, and the like, is correlated to each column. Here, the “student ID” is the identification information data separately assigned to each student who is operating the student terminal 200, and it is the same as the one stored in the student TBL 123. Further, in each item of the “1^{st} question”, “2^{nd} question”, and the like, the identification information data (a later mentioned question ID) which specifies the examination questions sent to the operation terminal 200 operated by the student specified by the “student ID”, is stored, in accordance with the sending order.

Next, explanation is given for a question TBL 125. The question TBL 125 is the data table in which information on the individual examination questions set in the conducted examination is stored. The question TBL 125 is correlated to the question DB 11 in the examination conducting support device 1 of FIG. 1.

FIG. 4E illustrates a data example of a question TBL 125. The question TBL 125 has a configuration in which each piece of data of a “question ID”, “question”, “option 1”, “option 2”, “option 3”, “option 4”, “correct answer”, and “replacement flag” is correlated to each column.

The “question ID” is the identification information data separately assigned to the examination question stored in the question TBL 125.

The “question” is the data of the question sentences of the examination question which is stored in the question TBL 125. In the present example, all the examination questions stored in the question TBL 125 are defined as a multiple selection type in which the student selects one correct option out of four options.

The “option 1”, “option 2”, “option 3”, and “option 4” are the data of the four options on the answers for the examination question indicated in the “question” data.

The “correct answer” is the data which indicates that the correct answer for the examination question indicated by the “question” data is any one of the “option 1”, “option 2”, “option 3”, and “option 4”.

The “replacement flag” is flag data and it is the data for displaying that the corrected question obtained by correcting the examination question specified by the “question ID” has been stored in the question TBL 125.

Next, explanation is given for a correct/incorrect management TBL 126. The correct/incorrect management TBL 126 is the table in which information on a progress state of the answer by each student for the examination question given to him, and a status of correctness or incorrectness for the answer, is stored. FIGS. 4F and 4G illustrate a data example of a correct/incorrect management TBL 126.

In the correct/incorrect management TBL 126 illustrated in FIGS. 4F and 4G, the student specified by the “student ID” data and the determination result (indicated by o and X) of whether the answer by the student for the examination question specified by the question ID “Q01”, “Q02”, and “Q03” is correct or incorrect are correlated. Here, the examination question for which the above determination result of correctness or incorrectness for the answer is not indicated (blank) indicates that the student has not yet answered (the answer has not been received from the student terminal 200). “The number of answered questions” is the data of the number of answers (quantity of answers) which were sent from the student terminal 200 operated by the student specified by the “student ID” data, and it is the total number of examination questions in which the above mentioned determination result of correctness or incorrectness is displayed for the student.

Further, in the correct/incorrect management TBL 126, each item of “the number of answerers”, “the number of incorrect answerers”, and an “incorrect-answer ratio” is provided at the lowest three lines. Here, “the number of answerers” is the data of the number of students (the number of answer receipts) who answered the examination questions specified by the question ID. “The number of incorrect answerers” is the data of the number of students who answered incorrectly to the examination questions specified by the question ID. “The incorrect-answer ratio” is the data of the incorrect-answer ratio on the examination questions specified by the question ID. Here, the incorrect-answer ratio of the examination questions refers to a percentage which indicates the ratio of the value of the above mentioned “number of incorrect answerers” to the value of “the number of answerers”.

Next, explanation is given for a bad-question determining index TBL 127. The bad-question determining index TBL 127 is the data table in which information on a determination condition in determining the presumption or decision whether the examination question is a bad question is stored. FIG. 4H illustrates a data example of a bad-question determining index TBL 127.

The bad-question determining index TBL 127 has a configuration in which each piece of data of an “index number”, “bad-question determining index”, and “parameter” is correlated to each column. Here, the “index number” is the identification information data separately assigned to each column of the bad-question determining index TBL 127. In the “bad-question determining index”, the above mentioned determination condition expressed with variables is stored. The “parameter” is the data which indicates specific values on the variables used in the “bad-question determining index”.

Specific explanation is given for a data example of FIG. 4H. In the first column, a determination condition is indicated in which, when the incorrect-answer ratio for an examination question answered by ‘10’ answerers, as ‘index 1’, is ‘70%’ or greater, the examination question is ‘presumed’ to be a bad question. In the second column, the determination condition is indicated in which, when the incorrect-answer ratio for the examination question answered by ‘20’ answerers, as ‘index 2’, is ‘70%’ or greater, the examination question is ‘decided’ to be a bad question.

Next, explanation is given for a bad-question determining index application management TBL 128. The bad-question determining index application management TBL 128 is the data table used for controlling the conducting state of the bad-question determination on the basis of the above mentioned determination condition stored in the bad-question determining index TBL 127, for each examination question stored in the question TBL 125. FIG. 4I illustrates a data example of a bad-question determining index application management TBL 128.

In the correct/incorrect management TBL 126 illustrated in FIG. 4I, the examination question specified by the “question ID” data and the determination condition specified by ‘index 1’ and ‘index 2’ which are the above mentioned index numbers are correlated. Here, in each section, either ‘applied’ or ‘not yet applied’ is stored. Here, when ‘applied’ is stored, it indicates that, as a result of the determination on the basis of the determination condition specified by the index number for the examination question specified by the question ID, the examination question has been presumed or decided to be a bad question. On the other hand, when ‘not yet applied’ is stored, it indicates that the determination on the basis of the determination condition specified by the index number for the examination question specified by the question ID has not yet been conducted, or as a result of the determination, the examination question has not been presumed or decided to be a bad question.

Next, explanation is given for a replacement target student TBL 129. The replacement target student TBL 129 is the data table used for controlling a student who is the question target to whom the examination question is preferentially replaced with the other examination question in order to decide a correctness or incorrectness of the presumption for the examination question presumed to be a bad question. FIG. 4J illustrates a data example of a replacement target student TBL 129.

The replacement target student TBL 129 has a configuration in which each piece of data of a “question ID”, “number”, and “student ID” is correlated to each column. Here, the “question ID” is the identification information data for specifying the examination question presumed to be the bad question, and it is the same as the one which is stored in the question TBL 125. The “number” is the numerical value which indicates a priority order of the student as the question target to whom the examination question specified by the “question ID” is given, with the examination question being replaced with the other examination question, and a smaller value indicates the higher priority order. Further, the “student ID” is the identification information data for specifying the student as the examination target to whom the examination question specified by the “question ID” is given and it is the same as the one which is stored in the student TBL 123.

A variety of data tables included in the server device 110 of FIG. 2 have a data structure as mentioned so far above. Next, explanation is given for a processing content of a variety of control processing which is performed by utilizing these data tables in each of the server device 110, teacher terminal 150, and student terminal 200.

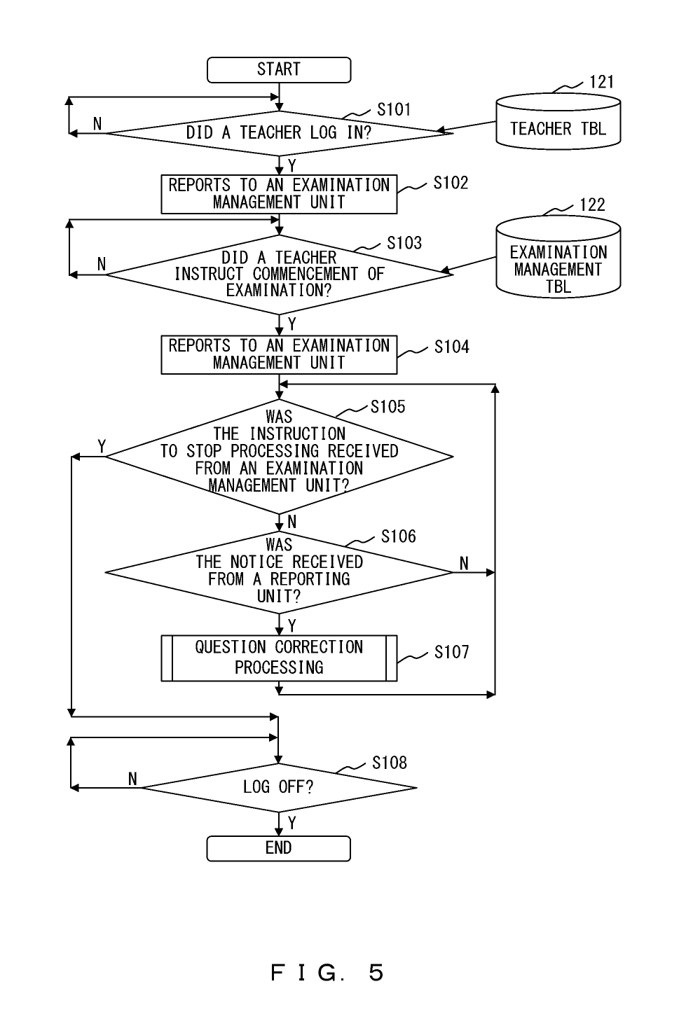

First, explanation is given for teacher terminal operation processing performed by the teacher terminal operating unit 151 of the teacher terminal 150. FIG. 5 illustrates a flow chart which illustrates, in a diagram, a processing content of teacher terminal operation processing.

The processing of FIG. 5 is started when the prescribed instruction to start processing for the teacher terminal 150 is detected.

In FIG. 5, first, in step S 101, the teacher terminal operating unit 151 performs the processing of determining whether the teacher who is operating the teacher terminal 150 has logged into the examination conducting support system 100. In the determination processing, first, for example, the processing of obtaining the teacher ID and the password which are input by the prescribed operation by the teacher for a non-illustrated operating unit (for example, the input device 35 of the computer 30 which functions as the teacher terminal 150) included in the teacher terminal 150 is performed. Next, the processing of determining whether combinations of the obtained teacher ID and the password agree with the combinations stored in the same column in the teacher TBL 121 is performed. Here, the teacher terminal operating unit 151, when it determines that the teacher has executed a log-in (when the determination result is Yes), moves the processing on to step S 102. On the other hand, the teacher terminal operating unit 151, when it determines that the teacher has not yet executed a log-in (when the determination result is No), repeats the processing of step S 101 until the log-in is detected.

Next, in step S 102, the teacher terminal operating unit 151 performs the processing of reporting, to the examination management unit 112, the detection of the log-in by the teacher.

Next, in step S 103, the teacher terminal operating unit 151 performs the processing of determining whether the prescribed instruction to start the examination from the teacher who is operating the teacher terminal 150 has been obtained. In the determination processing, for example, processing of obtaining the teacher ID and the examination ID input by the prescribed operation for the above mentioned operating unit included in the teacher terminal 150 is performed. Next, the processing of determining whether the combinations of the obtained teacher ID and the examination ID agree with the combinations of the obtained teacher ID and the examination ID stored in the same column in the examination management TBL 122 is performed. Here, the teacher terminal operating unit 151, when it determines that the prescribed instruction to start the examination from the teacher has been obtained (when the determination result is Yes), moves the processing on to step S 104. On the other hand, the teacher terminal operating unit 151, when it determines that the prescribed instruction to start the examination from the teacher has not been obtained (when the determination result is No), repeats the processing of step S 103 until the instruction to start the examination is detected.

Next, in step S 104, the teacher terminal operating unit 151 performs the processing of reporting, to the examination management unit 112, the obtainment of the instruction to start the examination from the teacher.

Next, in step S 105, the teacher terminal operating unit 151 performs the processing of determining whether the instruction to stop processing sent from the examination management unit 112 has been received. Here, when the teacher terminal operating unit 151 determines that the instruction to stop processing has been received (when the determination result is Yes), it moves the processing on to step S 109, and when the operating unit 151 determines that the instruction to stop processing has not been received (when the determination result is No), it moves the processing on to step S 106.

Next, in step S 106, the teacher terminal operating unit 151 performs the processing of determining whether a prescribed notice has been received from the reporting unit 117, the prescribed notice indicating that an examination question decided to be a bad question has been found. Here, the teacher terminal operating unit 151, when it determines that the prescribed notice has been received (when the determination result is Yes), moves the processing on to step S 107. On the other hand, when the teacher terminal operating unit 151 determines that the prescribed notice has not been received (when the determination result is No), it returns the processing to step S 105 and repeats the above mentioned processing.

Next, in step S 107, the teacher terminal operating unit 151, together with the question correcting unit 118, performs the question correction processing, and after that, the processing is returned to step S 105 and the above mentioned processing is repeated. The detail of the question correction processing will be mentioned later.

Next, in step S 108, the teacher terminal operating unit 151 performs the processing of whether the teacher who is operating the teacher terminal 150 has executed a log-off for the examination conducting support system 100. In the determination processing, first, for example, the processing of whether the instruction for the log-off input by the prescribed operation for the above mentioned operating unit included in the teacher terminal 150 has been obtained is performed. Here, the teacher terminal operating unit 151, when it determines that the teacher has executed a log-off (when the determination result is Yes), finishes the teacher terminal operation processing. On the other hand, the teacher terminal operating unit 151, when it determines that the teacher has not executed a log-off (when the determination result is No), repeats the processing of step S 108 until the log-off is detected.

The processing explained so far above is the teacher terminal operation processing.

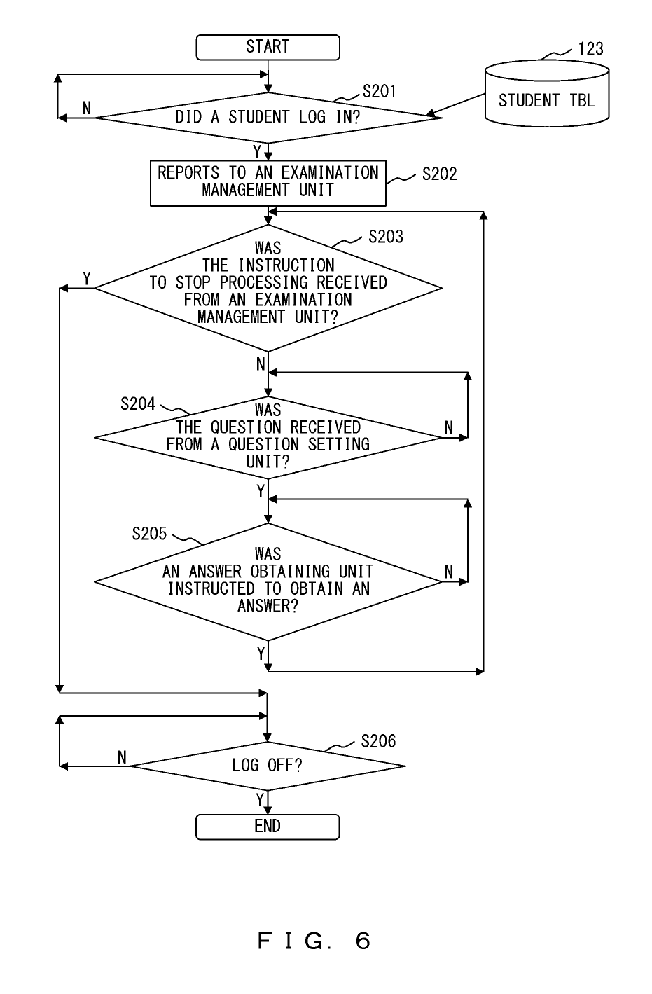

Next, explanation is given for student terminal operation processing performed by the student terminal operating unit 201 of the student terminal 200. FIG. 6 illustrates a flow chart which illustrates, in a diagram, a processing content of student terminal operation processing.

The processing of FIG. 6 is started when the prescribed instruction to start processing for the student terminal 200 is detected.

In FIG. 6, first, in step S 201, the student terminal operating unit 201 performs the processing of determining whether a student who is operating the student terminal 200 has logged into the examination conducting support system 100. In the determination processing, first, for example, the processing of obtaining the student ID and the password input by the student using the prescribed operation for a non-illustrated operating unit (for example, the input device 35 of the computer 30 which functions as the student terminal 200) included in the student terminal 200 is performed. Next, the processing of determining whether the combinations of the obtained student ID and the password agree with the combinations stored in the same column in the teacher TBL 121 is performed. Here, the student terminal operating unit 201, when it determines that the student has executed a log-in (when the determination result is Yes), moves the processing on to step S 202. On the other hand, the student terminal operating unit 201, when it determines that the student has not executed a log-in (when the determination result is No), repeats the processing of step S 201 until the log-in is detected.

Next, in step S 202, the student terminal operating unit 201 performs the processing of reporting, to the examination management unit 112, the detection of the log-in by the student.

Next, in step S 203, the student terminal operating unit 201 performs the processing of determining whether the instruction to stop processing sent from the examination management unit 112 has been received. Here, when the student terminal operating unit 201 that determines the instruction to stop processing has been received (when the determination result is Yes), it moves the processing on to step S 206. On the other hand, when the student terminal operating unit 201 determines that the instruction to stop processing has not been received (when the determination result is No), it moves the processing on to step S 204.

Next, in step S 204, the student terminal operating unit 201 performs the processing of determining whether the data on the examination question sent from the question sending unit 113 has been received. Here, when the student terminal operating unit 201 determines that the data on the examination question has been received (when the determination result is Yes), it moves the processing on to step S 205. On the other hand, when the student terminal operating unit 201 determines that the data on the examination question has not been received (when the determination result is No), it repeats the processing of step S 204 until the data on the examination question is received.

Next, in step S 205, the student terminal operating unit 201 performs the processing of determining whether the instruction to obtain the answer to the answer obtaining unit 114 has been performed.

In the processing of step S 205, first, the student terminal operating unit 201 performs the processing of retrieving, from the data on the examination question in which the receipt has been detected by the processing of step S 204, a question ID data, a question data, and an option data. Next, the student terminal operating unit 201 performs the processing of displaying, on the non-illustrated display unit included in the student terminal 200 (for example, the display device 36 of a computer 30 which functions as the student terminal 200), the examination questions and the answer options of the examination questions indicated by these data). Next, the student terminal operating unit 201 performs the processing of obtaining answer information (option information from the options) led by the students from the examination questions, the answer information being input by a prescribed operation by the student for the above mentioned operating unit included in the student terminal 200. When obtaining the answer information, the student terminal operating unit 201 performs the processing of instructing, to the answer obtaining unit 114, to obtain the obtained answer information, the above mentioned question ID data, and the answer which includes the student ID of the student who is operating the student terminal 200.

In the determination processing of step S 205, the student terminal operating unit 201, when it determines that it has instructed, to the answer obtaining unit 114, to obtain the answer as mentioned above (when the determination result is Yes), repeats the above mentioned processing, returning the processing to step S 203. On the other hand, when the student terminal operating unit 201, when it determines that it has not instructed, to the answer obtaining unit 114, to obtain the answer as mentioned above (when the determination result is No), repeats the above processing of step S 205 until it performs the instruction.

Next, in step S 206, the student terminal operating unit 201 performs the processing of determining whether the student who is operating the student terminal 200 has executed log-off for the examination conducting support system 100. In the determination processing, first, for example, the processing of determining whether the instruction for log-off input by the prescribed operation for the above mentioned operating unit included in the student terminal 200 has been obtained. The student terminal operating unit 201, when it determines that the student has executed log-off (when the determination result is Yes), finishes the student terminal operation processing. On the other hand, when the student terminal operating unit 201 determines that the student has not executed log-off (when the determination result is No), it repeats the processing of step S 206 until the log-off is detected.

Explanation for the student terminal operation processing has been given so far.

Next, explanation is given for control processing performed in each functional block of the server device 110.

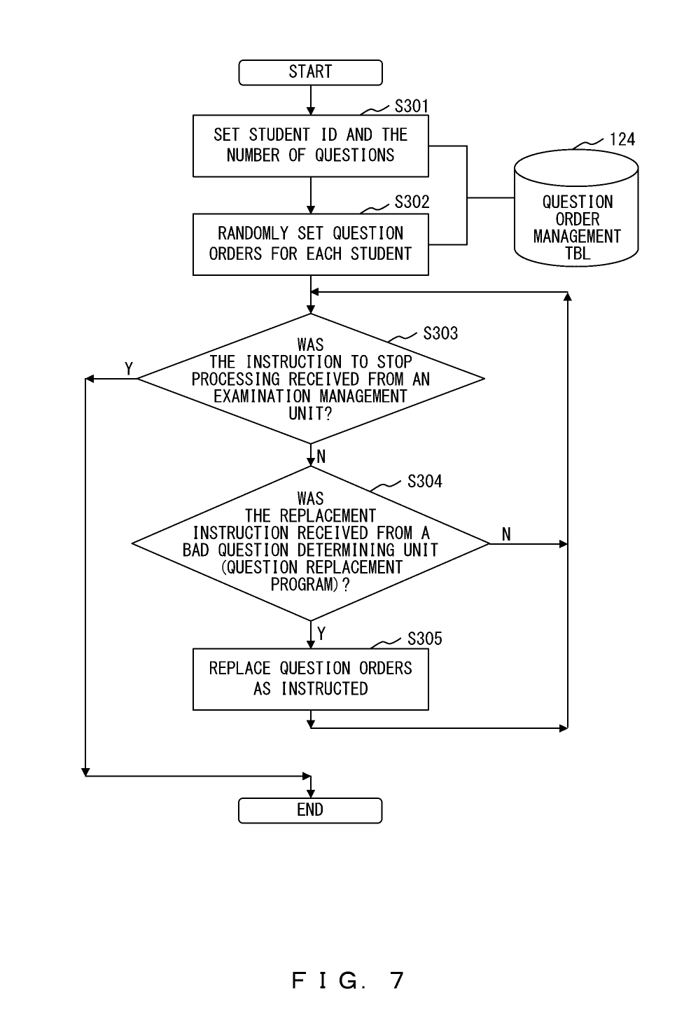

First, explanation is given for question order management processing performed by the question order management unit 111. FIG. 7 illustrates a flow chart which illustrates, in a diagram, a processing content of question order management processing.

The processing of FIG. 7 is started when the instruction to start the prescribed initialization processing for the server device 110 is detected.

In FIG. 7, insteps S 301 and S 302, the question order management unit 111 performs processing of storing the data for the question order management TBL 124.

More specifically, first, in step S 301, the question order management unit 111 performs processing of deciding the size (number of rows and columns) of the question order management TBL 124, by obtaining information on the student ID of each student who takes the examination to be conducted and on the number of questions given in the examination. The information on the student ID and on the number of questions given is input beforehand by the teacher who is operating the teacher terminal 150. In each row of the question order management TBL 124, the obtained student ID is stored.

Next, in step S 302, the question order management unit 111 obtains, from the question TBL 125, the question ID of the examination question of the number of questions obtained in the processing of S 301 and performs the processing of storing, in the question order management TBL 124, the obtained question ID in a different order for each student ID.

The processing of the above mentioned steps S 301 and S 302 is finished before the start of the examination to be conducted.

Next, in step S 303, the question order management unit 111 performs the processing of determining whether the instruction to stop processing sent from the examination management unit 112 has been received. Here, when the question order management unit 111 determines that the instruction to stop processing has been received (when the determination result is Yes), it finishes the question order management processing. On the other hand, when the question order management unit 111 determines that the instruction to stop processing has not been received (when the determination result is No), it moves the processing on to step S 304.

Next, in step S 304, the question order management unit 111 performs the processing of determining whether the instruction to replace the question order of the examination questions sent from the bad-question determining unit 116 or the question correcting unit 118 has been received. Here, when the question order management unit 111 determines that the instruction for replacement has been received (when the determination result is Yes), it moves the processing on to step S 305. On the other hand, when the question order management unit 111 determines that the instruction for replacement has not been received (when the determination result is No), it repeats the above mentioned processing, returning the processing to step S 303.

Next, in step S 305, the question order management unit 111 performs the processing of replacing the question order of the examination questions for each student ID stored in the question order management TBL 124 in accordance with the instruction content of the above mentioned instruction for replacement, the receipt of the instruction for replacement having been detected. Details of the processing of replacing the question order of the examination questions will be mentioned later. When the processing is finished, the question order management unit 111 repeats the above mentioned processing, returning the processing to step S 303.

Explanation for the question order management processing has been given so far.

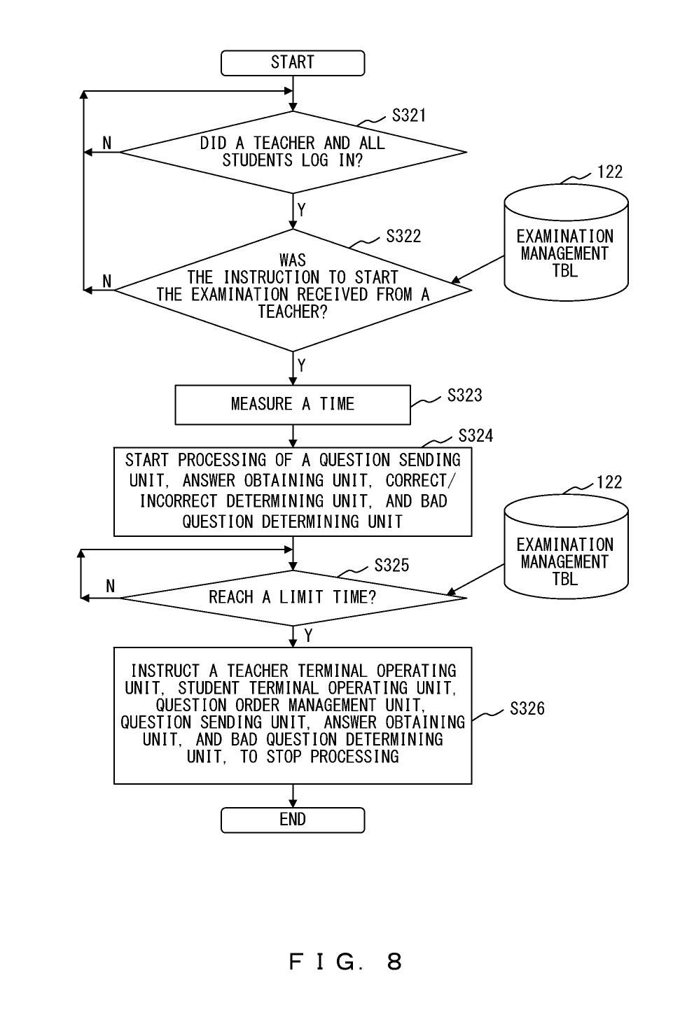

Next, explanation is given for examination management processing performed by the examination management unit 112. FIG. 8 illustrates a flow chart which illustrates, in a diagram, a processing content of examination management processing.

The processing of FIG. 8 is started when the prescribed instruction to start the examination management processing for the server device 110 is detected.

In FIG. 8, first, in step S 321, the examination management unit 112 performs the processing of determining whether the teacher who is operating the teacher terminal 150 and all students who are operating a plurality of student terminals 200 have respectively executed log-in. The determination is performed whether the server device 110 has received the notice sent from the teacher terminal 150 by the processing of step S 102 of FIG. 5 and the notice sent from each of the student terminals 200 by the processing of step S 202 of FIG. 6. Here, when the examination management unit 112 determines that the teacher and all the students have executed a log-in (when the determination result is Yes), it moves the processing on to step S 322. On the other hand, when the examination management unit 112 determines that one or more of the teacher and all the students have not executed log-in (when the determination result is No), it repeats the processing of step S 321 until it detects the log-in by the teacher and all the students.

Next, in step S 322, the examination management unit 112 performs the processing of determining whether the prescribed instruction to start the examination from the teacher has been obtained. The determination is performed whether the server device 110 has received the notice sent from the teacher terminal 150 operated by the teacher, with the teacher ID being stored in the teacher terminal 150 as the teacher in charge ID. Here, when the examination management unit 112 determines that the prescribed instruction to start the examination from the teacher has been obtained (when the determination result is Yes), it moves the processing on to step S 323. On the other hand, when the examination management unit 112 determines that the prescribed instruction to start the examination from the teacher has not been obtained (when the determination result is No), it repeats the processing of step S 322 until the instruction to start the examination is detected.

Next, in step S 323, the examination management unit 112 performs

the processing of measuring a lapsed time from the examination start, by starting a timing operation of the non-illustrated timer (for example, a timer included in the MPU 31 of the computer 30 which functions as a server device 110).

Next, in step S 324, the examination management unit 112 performs the processing of starting the processing of each unit by sending a prescribed start instruction to the question sending unit 113, the answer obtaining unit 114, the correct/incorrect determining unit 115, and the bad-question determining unit 116.

Next, in step S 325, the examination management unit 112 performs

The processing of determining whether the lapsed time from the examination start for which the measurement is started in step S 323 has reached a limit time correlated to the teacher in charge ID in the examination control TBL 122. Here, when the examination management unit 112 determines that the lapsed time has reached the limit time (when the determination result is Yes), it moves the processing on to step S 326. On the other hand, when the examination management unit 112 determines that the lapsed time has not reached the limit time (when the determination result is No), it repeats the processing of step S 325 until the lapsed time reaches the limit time.

Next, in step S 326, the examination management unit 112 performs the processing of stopping the processing of each unit by sending a prescribed stop instruction to the teacher terminal operating unit 151, the student terminal operating unit 201, the question order management unit 111, the question sending unit 113, the answer obtaining unit 114, and the bad-question determining unit 116, and after that, the examination management processing finishes.

Explanation for the examination management processing has been given so far.

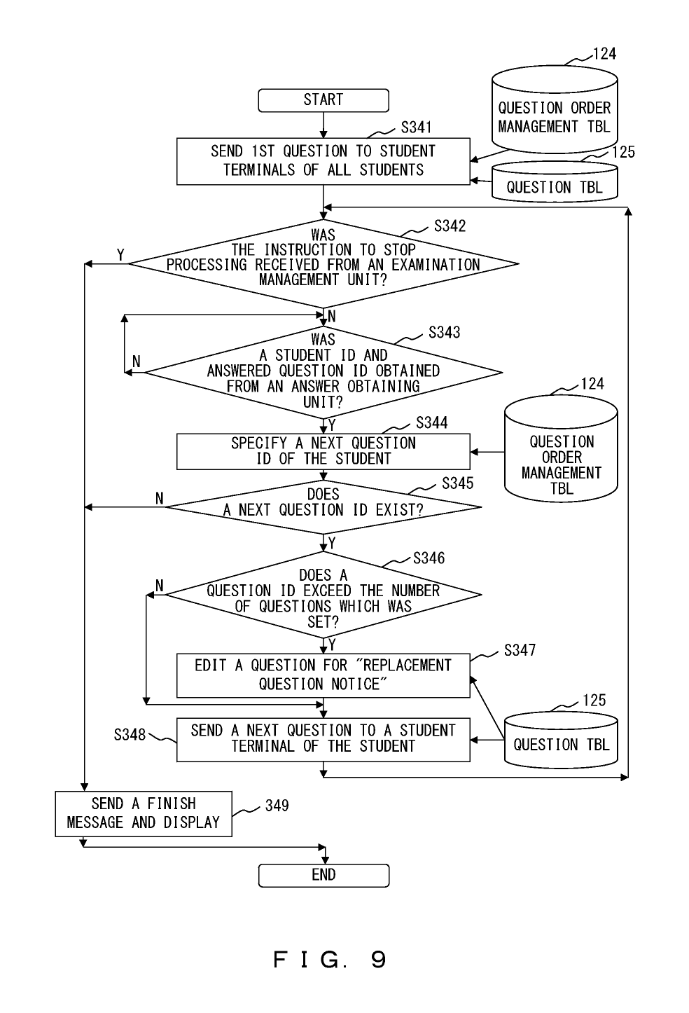

Next, explanation is given for question sending processing performed by the question sending unit 113. FIG. 9 illustrates a flow chart which illustrates, in a diagram, a processing content of question sending processing.

The processing of FIG. 9 is started when a prescribed start instruction sent from the examination management unit 112 by the processing of step S 324 of FIG. 8 is received.

In FIG. 9, in step S 341, first, the question sending unit 113 performs the processing of sending the first examination question to the student terminal 200 operated by each of the students who has logged into the server device 110. In the processing, first, the question sending unit 113 performs the processing of reading the first question ID correlated to the student ID of the students for each student who is operating the student terminal 200, by referring to the question order management TBL 124. Next, the question sending unit 113 performs the processing of reading the data of the questions and each option correlated to the question ID obtained for each student, by referring to the question TBL 125. Then, the question sending unit 113 performs the processing of sending, to the student terminal 200 operated by the student to whom the examination question of the question ID in the question order management TBL 124 is given as the 1^{st} question, the read data together with the question ID.

Next, in step S 342, the question sending unit 113 performs the processing of determining whether the instruction to stop processing sent from the examination management unit 112 which performed the processing of step S 326 of FIG. 8 has been received. Here, when the question sending unit 113 determines that the instruction to stop the processing has been received (when the determination result is Yes), it moves the processing on to step S 349, and when the question sending unit 113 determines that the instruction to stop the processing has not been received (when the determination result is No), it moves the processing on to step S 343.

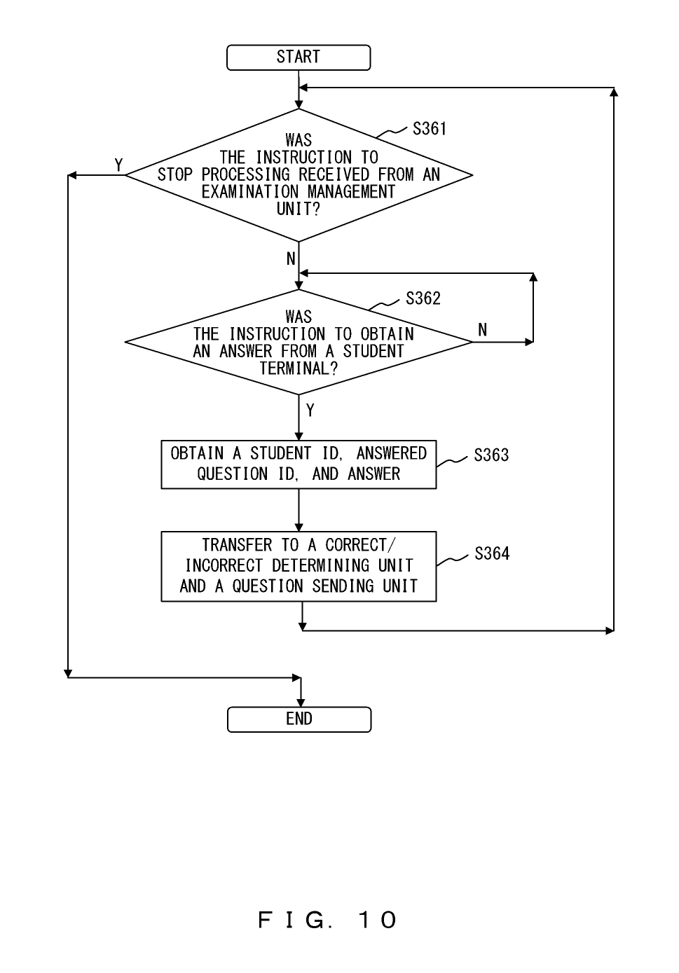

Next, in step S 343, the question sending unit 113 performs the processing of determining whether the data of the student ID and the answered question ID sent from the answer obtaining unit 114 which performed the later mentioned processing of step S 364 of FIG. 10 has been obtained. The answered question ID is the question ID for the question sent most recently from the question sending unit 113 to the student terminal 200 of the student specified by the student ID, and is included in the answer information for the questions received by the answer obtaining unit 114 from the student terminal 200. In the processing of step S 343, the question sending unit 113, when it determines that data of the student ID and the question ID has been obtained (when the determination result is Yes), moves the processing on to step S 344. On the other hand, the question sending unit 113, when it determines that the data of the student ID and the question ID has not been obtained (when the determination result is No), repeats the processing of step S 343 until the data is received from the answer obtaining unit 114.

Next, in step S 344, the question sending unit 113 performs the processing of specifying the question ID for the examination question subsequently given to the student specified by the student ID from each of the question IDs correlated to the student ID obtained from the answer obtaining unit 114, by referring to the question order management TBL 124.

Next, in step S 345, the question sending unit 113 performs the processing of determining whether the question ID for the examination question which is subsequently given has been specified by the processing of step S 344. Here, the question sending unit 113, when it determines that the question ID of the examination question which is subsequently given has been specified (when the determination result is Yes), moves the processing on to step S 346. On the other hand, the question sending unit 113, when it determines that the question ID of the examination question which is subsequently given has not been specified (that is, when all the examination questions up to the last question in the order indicated by the question order management TBL 124) have finished (when the determination result is No), moves the processing on to step S 349.

Next, in step S 346, the question sending unit 113 performs the processing of determining whether the question order of the question ID specified by the processing of step S 344 has exceeded the predetermined number of questions for the examination being conducted.

When the number of questions given in the examination exceeds the predetermined number of questions, sometimes, anew question with a corrected examination question by the later mentioned question correction processing is given to the student to whom the bad examination question was already given.

Here, the question sending unit 113, in the processing of step S 346, when it determines that the question order of the question ID has exceeded the predetermined number of questions (when the determination result is Yes), moves the processing on to step S 347. On the other hand, the question sending unit 113, when it determines that the question order of the question ID has not exceeded the predetermined number of questions (when the determination result is No), moves the processing on to step S 348.

Next, in step S 347, the question sending unit 113 performs the processing of reading the question data correlated to the question ID specified by the processing of step S 344 by referring to the question TBL 125, editing the examination question indicated by the question data, and adding the sentence which reports the addition of the corrected question.

Next, in step S 348, the question sending unit 113 performs the processing of sending the next examination question to the student terminal 200 of the student specified by the student ID which was determined to be obtained from the answer obtaining unit 114 by the processing of step S 343.

In the processing of step S 348, first, the question sending unit 113 performs the processing of reading data of the questions and each option correlated to the question ID specified by the processing of step S 344. Next, the question sending unit 113 performs the processing of sending, to the student terminal 200 of the student, the read data together with the question ID. The question sending unit 113, when it has already executed the editing processing of step S 347, performs the processing of sending, to the student terminal 200, the question data which indicates the examination questions after editing.

However, when the replacement flag correlated to the question ID is set in the processing of step S 348, the question sending unit 113 performs the processing of reading, from the question TBL 125, the data of questions and each option after correcting the examination questions specified by the question ID. In the data example of the question TBL 125 of FIG. 4E, the replacement flag correlated to the question ID of ‘Q10’ is set. Accordingly, the question sending unit 113 reads the information on the examination question of the corrected examination question ‘Q10”, instead of the information on the examination question ‘Q10’.

The question sending unit 113, after finishing the processing of step S 348, returns the processing to step S 342 and repeats the above mentioned processing.

Further, the question sending unit 113 performs the processing of sending, to the student terminal 200 operated by each of all the students who logs into the server device 110, the finishing message which indicates the end of the examination being conducted and displaying the finishing message.

Explanation for the question sending processing has been given so far.

Next, explanation is given for the answer obtainment processing performed by the answer obtaining unit 114. FIG. 10 illustrates a flow chart which illustrates, in a diagram, a processing content of answer obtainment processing.

The processing of FIG. 10 is started when the prescribed start instruction sent from the examination management unit 112 by the processing of step S 324 of FIG. 8 is received.

In FIG. 10, first, in step S 361, the answer obtaining unit 114 performs the processing of determining whether the instruction to stop the processing sent from the examination management unit 112 which performed the processing of step S 326 of FIG. 8 has been received. Here, the answer obtaining unit 114, when it determines that the instruction to stop processing has been received (when the determination result is Yes), finishes the answer obtainment processing. On the other hand, the answer obtaining unit 114, when it determines that the instruction to stop processing has not been received (when the determination result is No), moves the processing on to step S 362.

Next, in step S 362, the answer obtaining unit 114 performs the processing of determining whether the instruction to obtain answers sent from the student terminal 200 by the processing of step S 205 of FIG. 6 has been received. Here, the answer obtaining unit 114, when it determines that the instruction has been received (when the determination result is Yes), moves the processing on to step S 363. On the other hand, the answer obtaining unit 114, when it determines that the instruction has not been received (when the determination result is No), repeats the processing of step S 362 until the receipt of the instruction is detected.

Next, in step S 363, the answer obtaining unit 114 performs the processing of obtaining the student ID, the above mentioned answered question ID, and the answer information led by the student for the examination questions specified by the answered question ID that are included in the instruction to obtain the answer in which the receipt has been detected by the processing of step S 362.

Next, in step S 364, the answer obtaining unit 114 performs the processing of transferring, to the correct/incorrect determining unit 115 and question sending unit 113, a variety of information obtained by the processing of step S 363. In the processing, the data of the student ID and the answered question ID are sent to the question sending unit 113.

Explanation for the answer obtainment processing has been given so far.

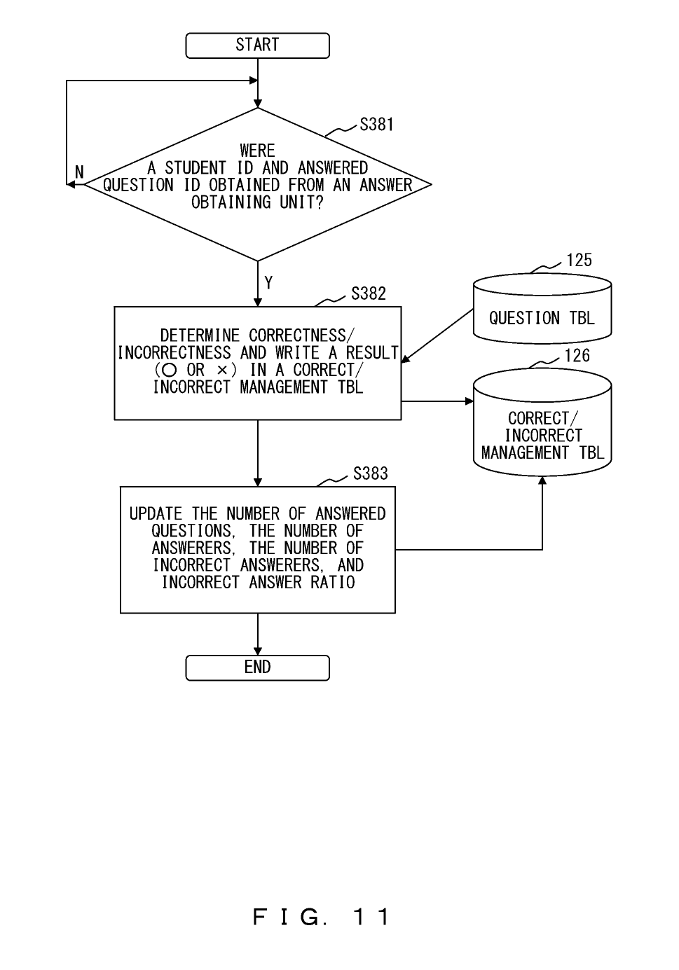

Next, explanation is given for the correct/incorrect determination processing performed by the correct/incorrect determining unit 115. FIG. 11 illustrates a flow chart which illustrates, in a diagram, a processing content of correct/incorrect determination processing.

The processing of FIG. 11 is started when a prescribed start instruction sent from the examination management unit 112 by the processing of step S 324 of FIG. 8 is received.

In FIG. 11, first, in step S 381, the correct/incorrect determining unit 115 performs the processing of determining whether the student ID, the answered question ID, and the answer information which are sent from the correct/incorrect determining unit 115 by the processing of step S 364 of FIG. 10 have been received. Here, the answer obtaining unit 114, when it determines that the data have been received (when the determination result is Yes), moves the processing on to step S 382. On the other hand, the correct/incorrect determining unit 115, when it determines that the data have not been received (when the determination result is No), repeats the processing of step S 381 until the receipt of the data is detected.

In step S 382, the correct/incorrect determining unit 115 performs the processing of determining whether the answer information received from the answer obtaining unit 114 is correct and stores the determination result in the correct/incorrect management TBL 126. In the processing, first, the correct/incorrect determining unit 115 performs the processing of obtaining correct answer data of the question specified by the answered question ID received from the answer obtaining unit 114. Next, the correct/incorrect determining unit 115 determines whether the obtained correct answer data agrees with the answer information received from the answer obtaining unit 114, and when the obtained data agrees with the answer information, the correct/incorrect determining unit 115 determines that the answer is correct, and when the obtained data does not agree with the answer information, the correct/incorrect determining unit 115 determines that the answer is incorrect. Then, the correct/incorrect determining unit 115 performs the processing of storing the determination result as a correct/incorrect determination result of the answer of the examination question specified by the answered question ID received from the answer obtaining unit 114, for the student ID received from the answer obtaining unit 114 in the correct/incorrect management TBL 126.

Next, in step S 383, along with storing the correct/incorrect determination result in the correct/incorrect management TBL 126 by the processing of step S 382, the correct/incorrect determining unit 115 performs the processing of updating values of each item of “the number of answerers”, “the number of incorrect answerers”, and “the number of answered questions”, and further, the correct/incorrect determining unit 115 performs the processing of calculating and updating “the incorrect-answer ratio”. When the correct/incorrect determining unit 115 finishes the processing of step S 383, the correct/incorrect determination processing is finished.

Explanation for the correct/incorrect determination processing has been given so far.

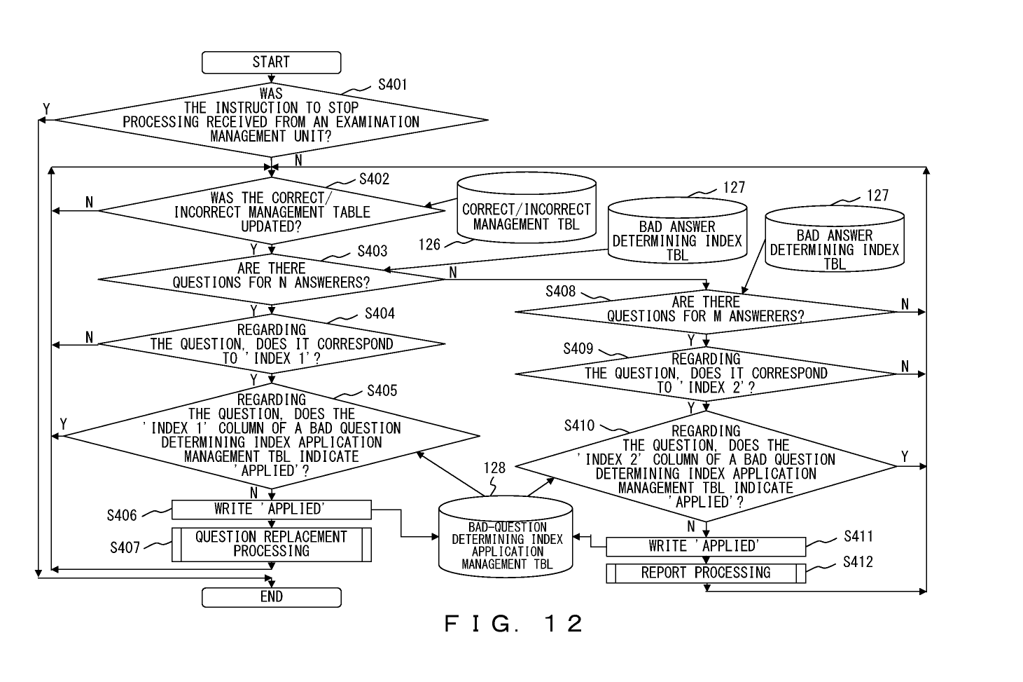

Next, explanation is given for the bad-question determination processing performed by the bad-question determining unit 116. FIG. 12 illustrates a flow chart which illustrates, in a diagram, a processing content of bad-question determination processing.

The processing of FIG. 12 is started, when a prescribed start instruction sent from the examination management unit 112 by the processing of step S 324 of FIG. 8 is received.

In FIG. 12, first, in step S 401, the bad-question determining unit 116 performs the processing of determining whether the instruction to stop processing sent from the examination management unit 112 which performed the processing of step S 326 of FIG. 8 has been received. Here, the bad-question determining unit 116, when it determines that the data instruction to stop the processing has been received (when the determination result is Yes), finishes the bad-question determination processing. On the other hand, the bad-question determining unit 116, when it determines that the data instruction to stop the processing has not been received (when the determination result is No), moves the processing on to step S 402.

Next, in step S 402, the bad-question determining unit 116 performs the processing of determining whether the processing for updating the correct/incorrect management TBL 126 by the correct/incorrect determining unit 115 has been performed. Here, the bad-question determining unit 116, when it determines that the updating of the correct/incorrect management TBL 126 has been performed (when the determination result is Yes), moves the processing on to step S 403. On the other hand, the bad-question determining unit 116, when it determines that the updating of the correct/incorrect management TBL 126 has not been performed (when the determination result is No), repeats the processing of step S 402 until the updating is detected.

The determination processing of steps S 403 and S 404 to be explained next is the processing on the basis of a determination condition of ‘index 1’ which is stored in the bad-question determining index TBL 127 illustrated in FIG. 4H.

First, in step S 403, the bad-question determining unit 116, by referring to each value stored in the column of “the number of answerers” in the correct/incorrect management TBL 126, performs the processing of determining whether a question exists in which the value of “the number of answerers” agrees with the value of variable n (in the example of FIG. 4H, ‘10’). The bad-question determining unit 116, when it determines that a question exists in which the value of “the number of answerers” agrees with the value of variable n (when the determination result is Yes), moves the processing on to step S 404. On the other hand, the bad-question determining unit 116, when it determines that no question exists in which the value of “the number of answerers” agrees with the value of variable n (when the determination result is No), moves the processing on to step S 408.

Next, in step S 404, the bad-question determining unit 116 performs the processing of determining whether the examination question in which the value of “the number of answerers” agrees with the value of variable n is matched with the determination condition of ‘index 1’ which is stored in the bad-question determining index TBL 127, and of determining whether the above mentioned examination question is presumed to be a bad question.

In the example of the correct/incorrect management TBL 126 of FIGS. 4F and 4G, the determination condition of ‘index 1’ is a case in which the incorrect-answer ratio on the examination question answered by n answerers is x % or greater. Accordingly, in the processing of step S 404, the bad-question determining unit 116 performs the processing of determining whether the incorrect-answer ratio on the examination question in which “the number of answerers” agrees with the value of variable n is x % (in the example of FIG. 4H, ‘70%’) or greater.

In the determination processing of step S 404, the bad-question determining unit 116, when it determines that the examination question in which “the number of answerers” agrees with the value of variable n is matched with the determination condition of ‘index 1’ (when the determination result is Yes), moves the processing on to step S 405. On the other hand, when the bad-question determining unit 116 determines that the examination question in which “the number of answerers” agrees with the value of variable n are not matched with the determination condition of ‘index 1’ (when the determination result is No), it returns the processing to step S 402 and repeats the above mentioned processing.

Next, in step S 405, the bad-question determining unit 116 performs the processing of determining whether ‘applied’ is already stored in the section of ‘index 1’ on the examination question in which “the number of answerers” agrees with the value of variable n, referring to the bad-question determining index application management TBL 128. Here, the bad-question determining unit 116, when it determines that ‘applied’ is already stored in the section (when the determination result is Yes), returns the processing to step S 402 and repeats the above mentioned processing. On the other hand, the bad-question determining unit 116, when it determines that ‘applied’ is not stored in the section (that is, ‘not yet applied’ is stored) (when the determination result is No), moves the processing on to step S 406.

Next, in step S 406, the bad-question determining unit 116 performs the processing of storing ‘applied’ in the section of ‘index 1’ on the examination question in which “the number of answerers” agrees with the value of variable n, and displaying that the examination question is presumed to be a bad question.

Next, in step S 407, the bad-question determining unit 116 performs the processing of replacing the question for the examination question presumed to be a bad question. Details of the processing of replacing the question will be mentioned later. When the processing of step S 407 is finished, the bad-question determining unit 116 restores the processing to step S 402 and repeats the above mentioned processing.

The determination processing of steps S 408 and S 409 to be explained next is the processing on the basis of a determination condition of ‘index 2’ which is stored in the bad-question determining index TBL 127 illustrated in FIG. 4H.

First, in step S 408, the bad-question determining unit 116, by referring to each value stored in the column of “the number of answerers” in the correct/incorrect management TBL 126, performs processing of determining whether a question exists in which the value of “the number of answerers” agrees with the value of variable m (in the example of FIG. 4H, ‘20’). The bad-question determining unit 116, when it determines that a question exists in which the value of “the number of answerers” agrees with the value of variable m (when the determination result is Yes), moves the processing on to step S 409. On the other hand, the bad-question determining unit 116, when it determines that no question exists in which the value of “the number of answerers” agrees with the value of variable m (when the determination result is No), returns the processing to step S 402 and repeats the above mentioned processing.

Next, in step S 409, the bad-question determining unit 116 performs the processing of determining whether an examination question in which the value of “the number of answerers” agrees with the value of variable m is matched with the determination condition of ‘index 2’ which is stored in the bad-question determining index TBL 127 and whether it is correct to decide that the above mentioned examination question is a bad question.

In the example of the correct/incorrect management TBL 126 of FIGS. 4F and 4G, the determination condition of ‘index 2’ is a case in which the incorrect-answer ratio on the examination question answered by m answerers is y % or greater. Accordingly, in the processing of step S 409, the bad-question determining unit 116 performs the processing of determining whether the incorrect-answer ratio on the examination question in which the value of “the number of answerers” agrees with the value of variable m is y % (in the example of FIG. 4H, ‘70%’) or greater.

In the determination processing of step S 409, the bad-question determining unit 116, when it determines that the examination question in which the value of “the number of answerers” agrees with the value of variable m is matched with the determination condition of ‘index 2’ (when the determination result is Yes), moves the processing on to step S 410. On the other hand, when the bad-question determining unit 116 determines that the examination question in which the value of “the number of answerers” agrees with the value of variable m isn't matched with the determination condition of ‘index 2’ (when the determination result is No), it returns the processing to step S 402 and repeats the above mentioned processing.

Next, in step S 410, the bad-question determining unit 116 performs the processing of determining whether ‘applied’ is already stored in the section of ‘index 2’ on the examination question in which the value of “the number of answerers” agrees with the value of variable m, referring to the bad-question determining index application management TBL 128. Here, the bad-question determining unit 116, when it determines that ‘applied’ is already stored in this section (when the determination result is Yes), returns the processing to step S 402 and repeats the above mentioned processing. On the other hand, the bad-question determining unit 116, when it determines that ‘applied’ is not stored in this section (that is, ‘not yet applied’ is stored) (when the determination result is No), moves the processing on to step S 411.

Next, in step S 411, the bad-question determining unit 116 performs the processing of storing ‘applied’ in the section of ‘index 2’ on the examination question in which the value of “the number of answerers” agrees with the value of the variable min the bad-question determining index application management TBL 128, and displaying that the examination question has been decided to be a bad question.

Next, in step S412, the bad-question determining unit 116 performs the processing of providing, to the reporting unit 117, a prescribed instruction which includes the question ID of the examination question which was decided to be a bad question. Details of the report processing will also be mentioned later. When the processing of step S 412 is finished, the bad-question determining unit 116 returns the processing to step S 402 and repeats the above mentioned processing.

Explanation for the bad-question determination processing has been given so far.

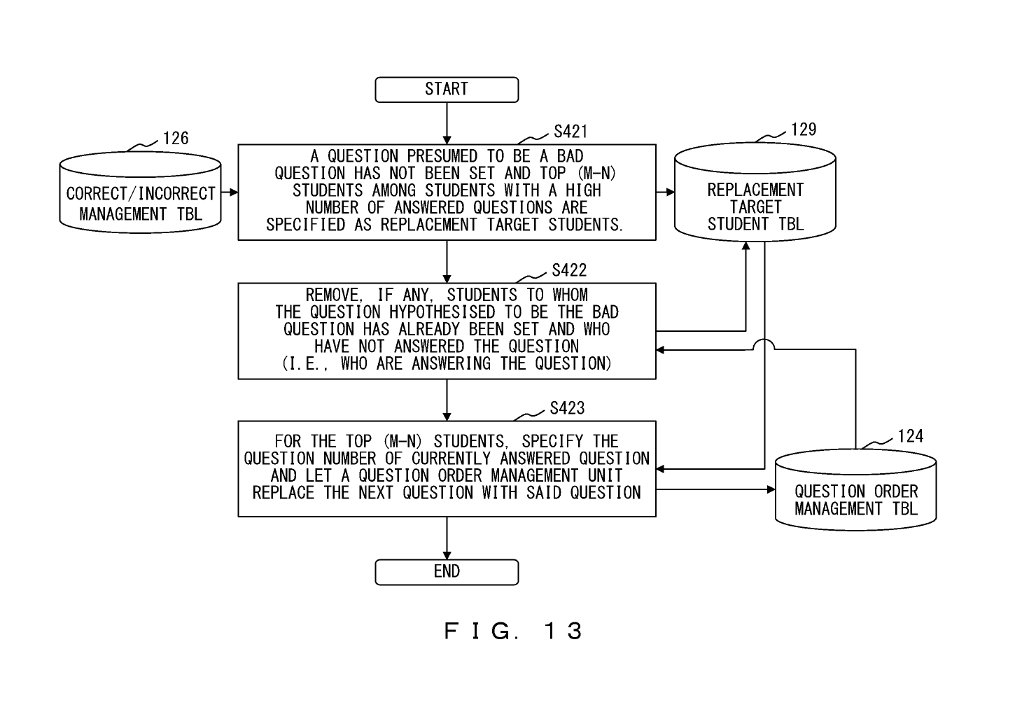

Next, explanation is given for question replacement processing which is the processing of step S 407 in the bad-question determination processing. FIG. 13 illustrates a flow chart which illustrates, in a diagram, a processing content of question replacement processing.

In FIG. 13, first, in step S 421, the bad-question determining unit 116 performs the processing of specifying (m-n) students to whom the examination question presumed to be a bad question to be replaced has not been given, in descending order of the number of answered questions as replacement target students. In the processing, first, the bad-question determining unit 116 refers to the correct/incorrect management TBL 126 and performs the processing of obtaining all student IDs which are correlated to the blanks in the columns of the question IDs of the examination question presumed to be a bad question to be replaced. Next, the bad-question determining unit 116 performs the processing of extracting the (m-n) student IDs in descending order of the number of answered questions indicated in the correct/incorrect management TBL 126 from the obtained student IDs. Then, the bad-question determining unit 116 performs the processing of storing, in the replacement target student TBL 129, the question ID of the examination question presumed to be a bad question, the extracted student IDs, and the number indicating the extracting order of the student IDs.

The processing of step S 421 is further explained, using specific data examples.

In the data example of the correct/incorrect management TBL 126 of FIGS. 4F and 4G, even though the number of answerers of the four questions with the question ID of ‘Q2’, ‘Q5’, ‘Q10’, and ‘Q14’ has already reached ‘10’, among them, the only question ID with an incorrect-answer ratio of ‘70%’ or greater is ‘Q10’. Accordingly, the bad-question determining unit 116 presumes only ‘Q10’ to be a bad question by the bad-question determination processing in FIG. 12.

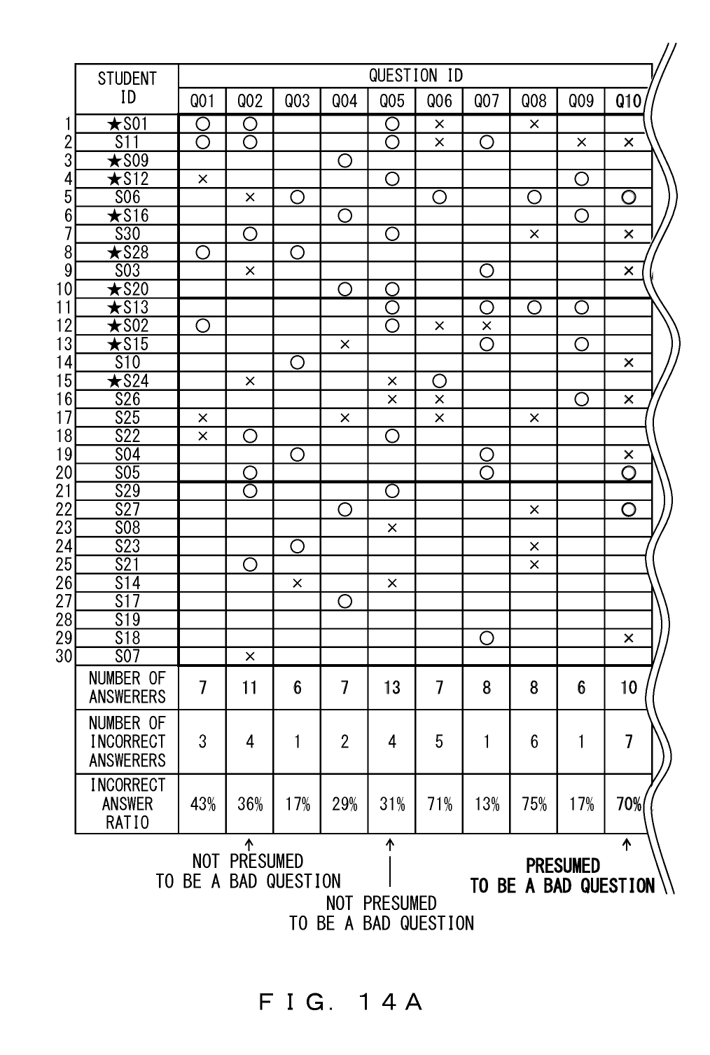

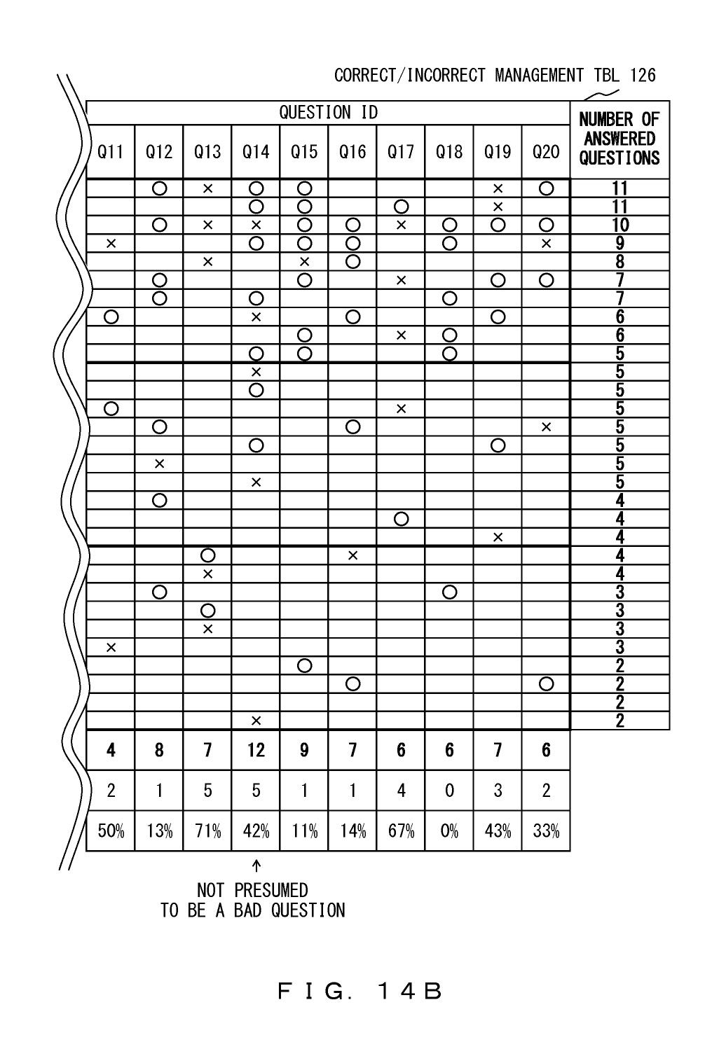

Next, the bad-question determining unit 116 performs the processing of step S 421 of FIG. 13, obtains the student IDs which correlate to the blank in the column of ‘Q10’ which was presumed to be a bad question, and extracts, therefrom, 10 (when m=20 and n=10) student IDs in descending order of the number of answered questions. As a result, the student IDs ‘S01’, ‘S09’, ‘S12’, ‘S16’, ‘S28’, ‘S30’, ‘S13’, ‘S02’, ‘S15’, and ‘S24’ are extracted. The data example of the correct/incorrect management TBL 126 indicated in FIGS. 14A and 14B schematically indicates the state in which the student IDs are extracted. In the data example of FIGS. 14A and 14B, asterisks are provided to the student IDs which were extracted as mentioned above.

Explanation is continued for the question replacement processing.

Next, in step S 422, when the examination question currently given to the students specified by the student IDs stored in the replacement target student TBL 129 is presumed to be a bad question, the bad-question determining unit 116 performs the processing of removing the column which correlates to the student ID and correcting the number. In the processing, first, the bad-question determining unit 116 refers to the question order management TBL 124 and performs the processing of obtaining the question ID of the examination question currently given to the student specified by the student ID stored in the replacement target student TBL 129. Next, the bad-question determining unit 116 performs the processing of determining whether the obtained question ID agrees with the question ID which is correlated to the student ID in the replacement target student TBL 129. Here, when the obtained question ID agrees with the question ID correlated to the student ID, the bad-question determining unit 116 performs the processing of removing, from the replacement target student TBL 129, the column which includes the student ID, and correcting the number which is correlated to the other student ID.

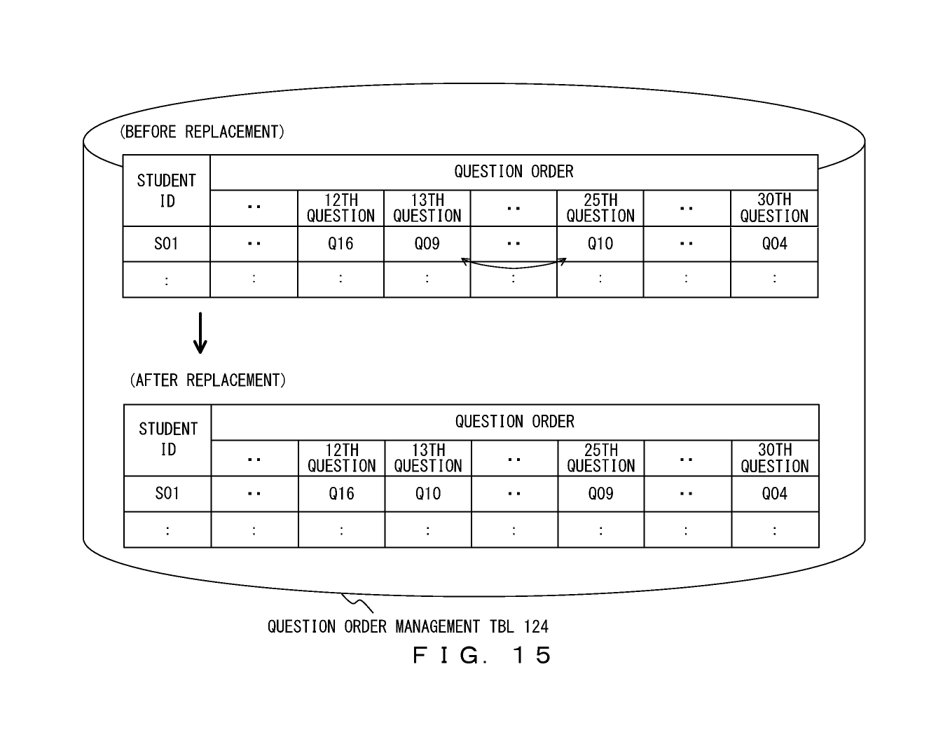

Next, in step S 423, the bad-question determining unit 116, by providing a prescribed instruction to the question order management unit 111, performs the processing of replacing the examination question presumed to be a bad question with the examination question which is subsequently given to the students specified by the student IDs which are stored in the replacement target student TBL 129. In the processing, the bad-question determining unit 116 reads the combinations of the question ID and the student IDs stored in the replacement target student TBL 129 and sends, to the question order management unit 111, the above mentioned prescribed instruction which includes the read question ID and the student IDs. The question order management unit 111 executes the processing of step S 305 of the above mentioned FIG. 7 and performs the processing of replacing the question order of the examination questions for the student IDs stored in the question order management TBL 124. Here, using FIG. 15, explanation is given for the processing content after replacement of the question order of the examination question performed by the question order management unit 111.

The data example of the question order management TBL 124 of FIG. 15 illustrates the data example before and after replacement of the question order of the examination question by the question order management unit 111 on the basis of the instructions from the bad-question determining unit 116 for the student whose student ID is ‘S01’.

Here, a case is assumed in which the bad-question determining unit 116 presumes that the examination question with a question ID of ‘Q10’ is a bad question and in which the bad-question determining unit 116 has provided the instructions, to the question order management unit 111, to replace the examination question for the student whose student ID is ‘S01’ to whom the examination question presumed to be a bad question has not been sent. It is further assumed that at this time, the student whose student ID is ‘S01’ is addressing the 12^{th} question.

At this time, the question order management unit 111 performs the processing of searching the question ID of ‘Q10’ from the column in which the student ID in the question order management TBL 124 is ‘S01’. With this search, ‘Q10’ stored in the section for the 25^{th} question is found, from the data example before replacement of the question order management TBL 124 of FIG. 15.

Next, the question order management unit 111 performs the processing of replacing the found question ID with the question ID for the examination questions subsequent to the examination question which the student is addressing. As mentioned above, it is the 12^{th} examination question which the student whose student ID is ‘S01’ is currently addressing. Accordingly, from the data example before replacement of the question order management TBL 124 of FIG. 15, ‘Q09’, which is the question ID of the 13^{th} examination question, which is subsequent to the 12^{th} examination question, is the target for replacement with the above mentioned ‘Q10’. Accordingly, the question order management unit 111 performs replacing the question ID to give the 13^{th} examination question as ‘Q10’, and to give the 25^{th} examination question as ‘Q09’. As a result, the examination question of ‘Q10’ which was presumed to be a bad question is sent preferentially to other examination questions, to the student terminal 200 of the student with the student ID of ‘S01’ with the larger number of answered questions (that is, being quick in answering) from among the students to whom the examination questions have not been sent.

The bad-question determining unit 116, after finishing the above mentioned processing of step S 423, finishes the question replacement processing.

Explanation for the question replacement processing has been given so far. The bad-question determining unit 116 performs the question replacement processing as the processing of step S 407 in the bad-question determination processing of FIG. 12. Then, in the determination processing of step S 408 of FIG. 12, when an examination question in which “the number of answerers” has reached a prescribed number is found, the bad-question determining unit 116 performs the determination processing of step S 409, and performs the determination of whether the examination question has been decided to be a bad question.

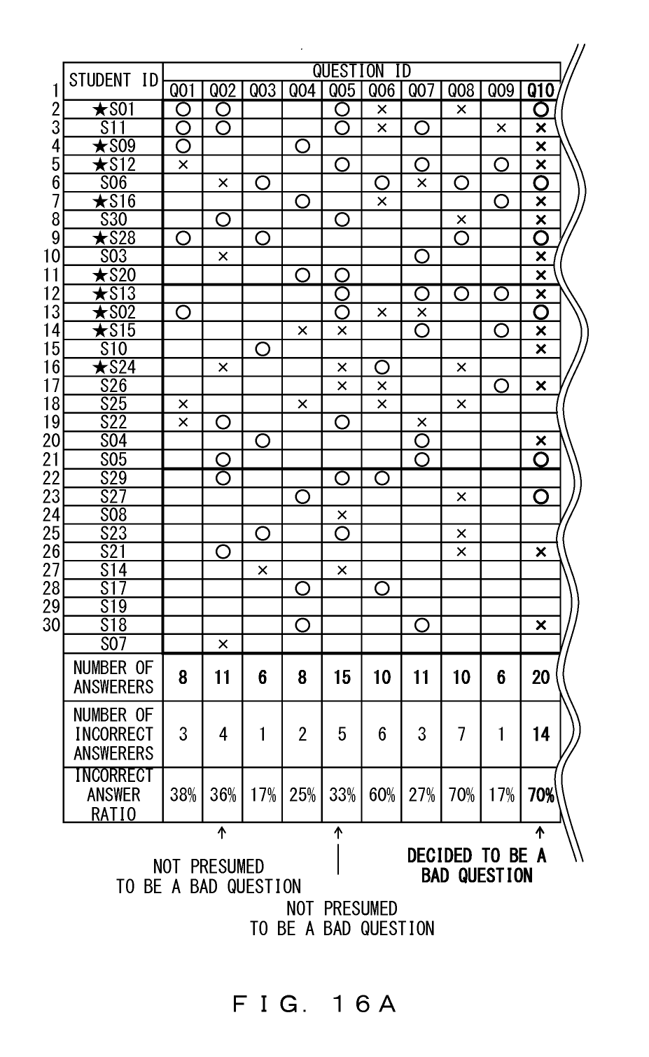

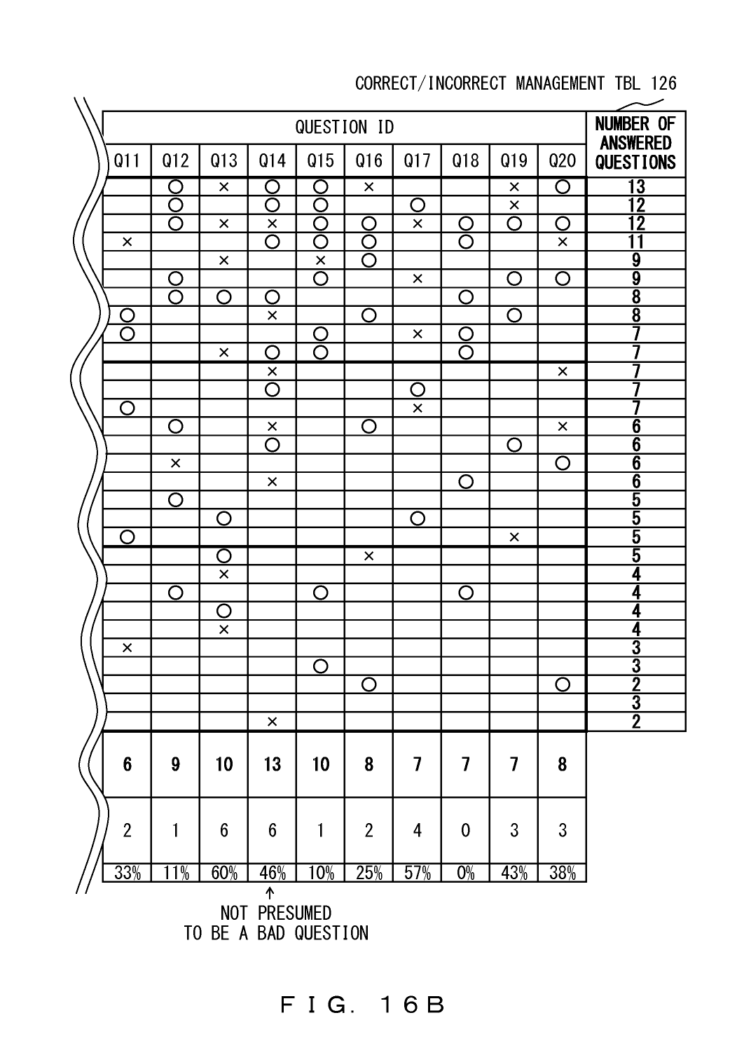

Here, explanation is given for the data example of the correct/incorrect management TBL 126 of FIGS. 16A and 16B. The data example is the data example with the correct/incorrect management TBL 126 updated by the correct/incorrect determining unit 115 from the data example illustrated in FIGS. 14A and 14B, and it is the data example obtained after the examination question ‘Q10’ presumed to be a bad question was given preferentially to the other examination questions to each student with the asterisks provided to the student ID.

The bad-question determining unit 116 performs the determination processing of step S 409, finding ‘Q10’ in which “the number of answerers” has reached ‘20’ from the data examples of the correct/incorrect management TBL 126 of FIGS. 16A and 16B. Then, the bad-question determining unit 116 decides the examination question ‘Q10’ with the incorrect-answer ratio of ‘70%’ is a bad question. Then, with the processing of steps S 410 and S 411, the bad-question determining unit 116 stores ‘applied’ in the section of ‘index 2’ on ‘Q10’ in the bad-question determining index application management TBL 128, and subsequently executes the report processing of step S 412.

In the example of FIGS. 16A and 16B, the presumption in which the examination question of ‘Q10’ is presumed to be a bad question by the bad-question determining unit 116 is decided to be correct by the subsequent processing of the bad-question determining unit 116. However, in the present example, such cases may be considered in which the examination question was not presumed to be a bad question by the bad-question determining unit 116, but such an examination question is nonetheless decided to be a bad question by the bad-question determining unit 116, as the incorrect-answer ratio which is the basis of the presumption is lowered later.

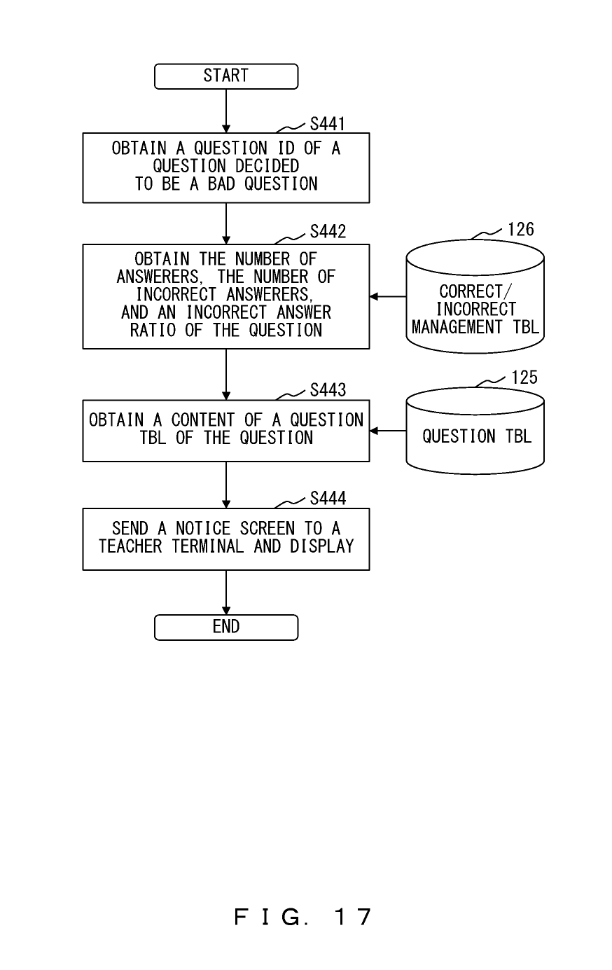

Next, explanation is given for report processing which is the processing performed by the reporting unit 117 in accordance with the processing of step S 412 in the bad-question determination processing of FIG. 12. FIG. 17 illustrates a flow chart which illustrates, in a diagram, a processing content of report processing.

In FIG. 17, first, in step S 441, the reporting unit 117 performs the processing of obtaining the question ID of the examination question that has been decided to be a bad question, and that is included in a prescribed instruction sent from the bad-question determining unit 116 which executed the processing of step S 412 of FIG. 12.

Next, in step S 442, the reporting unit 117 performs the processing of obtaining the data of “the number of answerers”, “the number of incorrect answerers”, and “the incorrect-answer ratio” on the question ID obtained by the processing of step S 441, referring to the correct/incorrect management TBL 126.

Next, in step S 443, the reporting unit 117 performs the processing of obtaining the content of the question (question data, option data, and correct answer data) stored in the column which includes the question ID obtained by the processing of step S 441, referring to the question TBL 125.

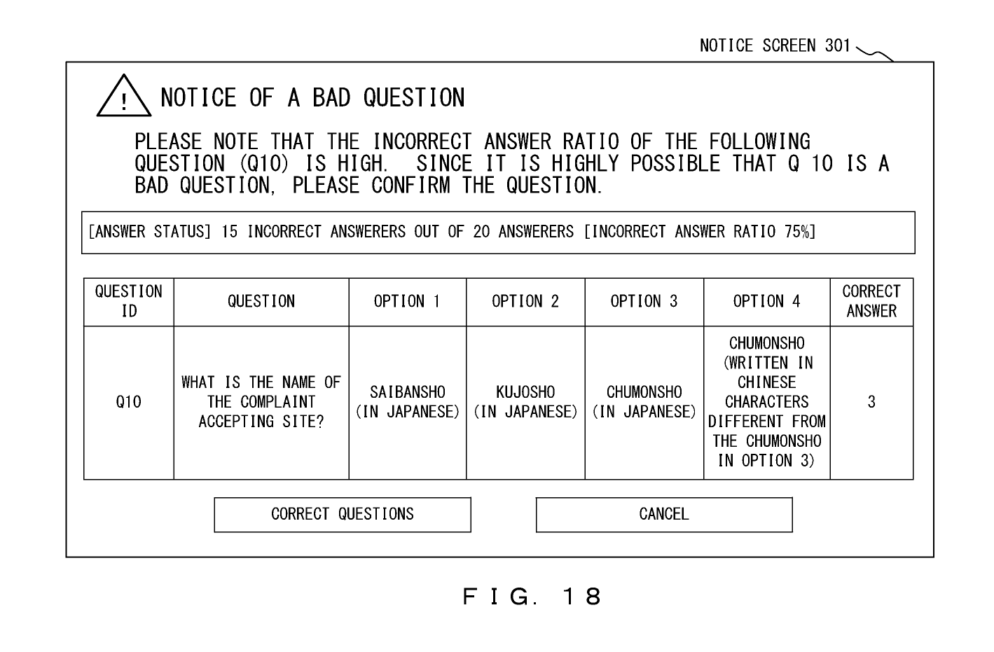

Next, in step S 444, the reporting unit 117 performs the processing of preparing the notice screen 301 as illustrated in FIG. 18, for displaying the content of a variety of data obtained by each process of steps S 441 to S 443 and displaying the notice screen 301, by sending, to the teacher terminal 150, the notice screen 301 together with a prescribed notice as mentioned above. When the reporting unit 117 finishes the processing of step S 444, the report processing is finished.

Explanation for the report processing has been given so far.

On the notice screen 301 illustrated in FIG. 18, a variety of data obtained by each process of steps S 441 to S 444 is displayed, and further, a sentence to encourage the teacher to confirm the examination question as well as reporting that it is highly possible that the examination question is a bad question. Further, in the notice screen 301, the button for “correcting the question” and the button for “cancellation” is included. The buttons are utilized in the subsequently explained question correction processing.

The teacher terminal 150, when receiving the notice screen 301, displays the received notice screen 301 on the non-illustrated operating unit (for example, the display device 36 of the computer 30 which functions as the teacher terminal 150) included in the teacher terminal 150. The teacher terminal operating unit 151 of the teacher terminal 150, when detecting to have received the notice in the determination processing of step S 106 of FIG. 5, starts executing the question correction processing of step S 107.

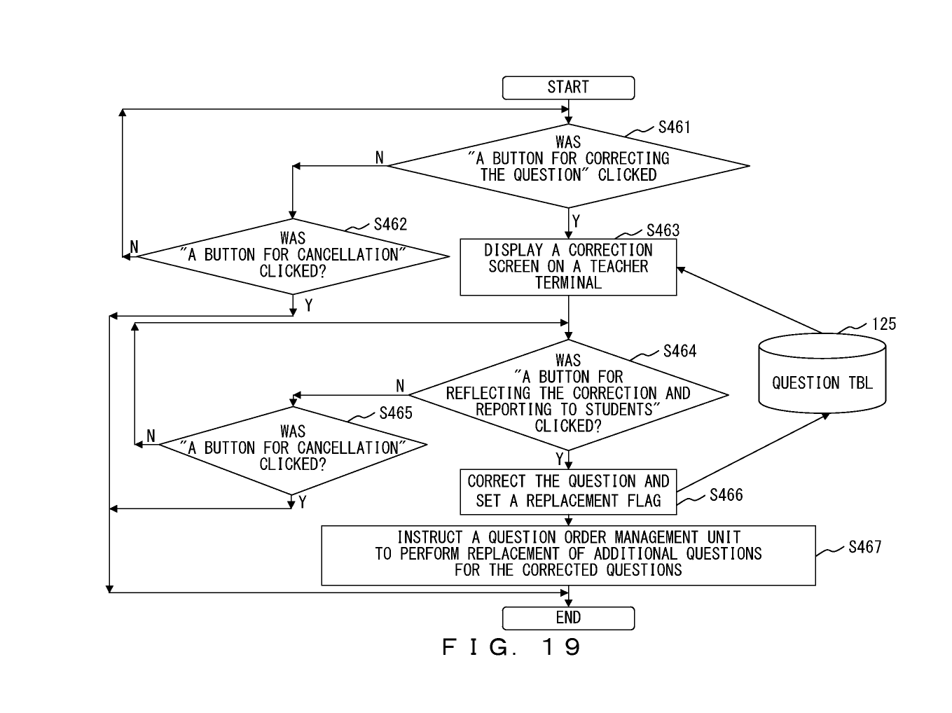

Next, explanation is given for the question correction processing performed by the question correcting unit 118 of the server device 110 and the teacher terminal operating unit 151 of the teacher terminal 150. FIG. 19 illustrates a flow chart which illustrates, in a diagram, a processing content of question correction processing.

In FIG. 19, first, in step S 461, the teacher terminal operating unit 151 performs the processing of determining whether a click operation on the button for “correcting the question” of the notice screen 301 by a prescribed operation of the teacher to the non-illustrated operation unit included in the teacher terminal 150 has been detected. Here, the teacher terminal operating unit 151, when it determines that the click operation has been detected (when the determination result is Yes), moves the processing on to step S 463, and when it determines that the click operation has not been detected (when the determination result is No), moves the processing on to step S 462.

Next, in step S 462, the teacher terminal operating unit 151 performs the processing of determining whether the click operation on the button “for cancellation” of the notice screen 301 by the prescribed operation by the teacher to the operating unit included in the teacher terminal 150 has been detected. Here, the teacher terminal operating unit 151, when it determines that the click operation has been detected (when the determination result is Yes), finishes the question correction processing. On the other hand, the teacher terminal operating unit 151, when it determines that the click operation has not been detected (when the determination result is No), returns the processing to step S 461 and repeats the above mentioned processing.

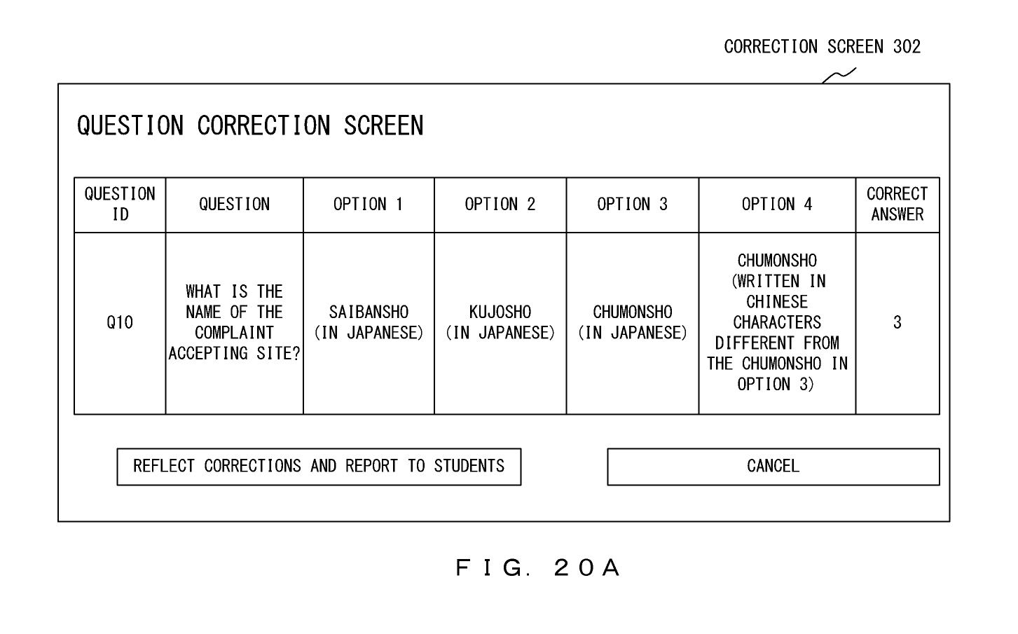

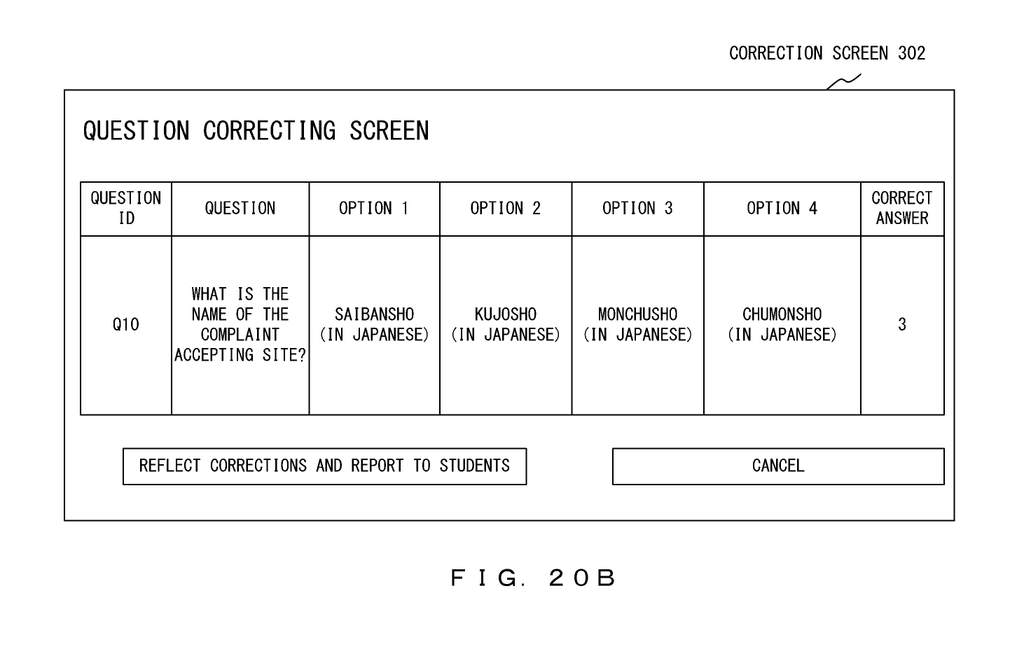

Next, in step S 463, the teacher terminal operating unit 151 performs the processing of preparing the correction screen 302 as illustrated in FIG. 20A, and displaying the correction screen 302 on the non-illustrated display unit included in the teacher terminal 150.

On the correction screen 302 illustrated in FIG. 20A, the content of the question (question data, option data, and correct answer data) obtained from the display content of the notice screen 301 illustrated in FIG. 18 is displayed. Further, in the correction screen 302, the button “for reflecting the correction and reporting to the students” and the button “for cancellation” are included.

The teacher, while seeing the display of the correction screen 302, operates the operating unit included in the teacher terminal 150, and inputs the correction content for the question data, option data, or the correct data. In the display screen 302 illustrated in FIG. 20B, the correction content input by the teacher is reflected in the content of the question which is displayed on the correction screen illustrated in FIG. 20 A, in which “chumonsho” (in Japanese) is corrected as “monchusho” (in Japanese).

The teacher, when the input of the correction content to the content of the question displayed on the correction screen 302 is finished, further operates the operating unit and inputs the click operation on the button “for reflecting the correction and reporting to the students”. On the other hand, when judging that the content correction of the question displayed on the correction screen 302 is not necessary, the teacher operates the operating unit and inputs the click operation to the button “for cancellation”.

Explanation is given, going back to FIG. 19.

Next, in step S 464, the teacher terminal operating unit 151 performs the processing of determining whether the click operation on the button “for reflecting the correction and reporting to the students” of the correction screen 302 by the prescribed operation by the teacher to the operating unit included in the teacher terminal 150 has been detected. Here, the teacher terminal operating unit 151, when it determines that the click operation has been detected (when the determination result is Yes), moves the processing on to step S 466, and when the teacher terminal operating unit 151 determines that the click operation has not been detected (when the determination result is No), it moves the processing on to step S 465.

Next, in step S 465, the teacher terminal operating unit 151 performs the processing of determining whether the click operation on the button “for cancellation” of the correction screen 302 by the prescribed operation by the teacher to the operating unit included in the teacher terminal 150 has been detected. Here, the teacher terminal operating unit 151, when it determines that the click operation has been detected (when the determination result is Yes), finishes the question correction processing. On the other hand, when the teacher terminal operating unit 151 determines that the click operation has not been detected (when the determination result is No), it returns the processing to step S 464 and repeats the above mentioned processing.

Next, in step S 466, the teacher terminal operating unit 151 and the question correcting unit 118 perform the processing of correcting the question stored in the question TBL 125 as well as setting a replacement flag. In the processing, first, the teacher terminal operating unit 151 performs the operation of sending, to the question correction unit 118, the information which indicates the correction content input by the teacher who is operating the operating unit included in the teacher terminal 150. The question correcting unit 118, when receiving the information, performs the processing of reading, from the question TBL 125, the information on the examination question specified by the question ID included in the information. Next, the question correcting unit 118 performs the processing of acquiring the corrected question by making corrections to the information on the read examination question, following the correction content received from the teacher terminal operating unit 151. Then, the question correcting unit 118 performs the processing of setting the replacement flag of the column in which the examination question before the correction is stored, as well as adding the information on the corrected question. With this processing, the replacement flag which is correlated to the question ID of the examination question for which it has been decided to be a bad question in the question TBL 125 is set. Accordingly, the question sending unit 113 may send the information on the corrected question instead of the examination question that has been decided to be a bad question upon the replacement flag being set, when executing the above mentioned processing of step S 348 of FIG. 9 and sending the examination questions to the student terminal 200.

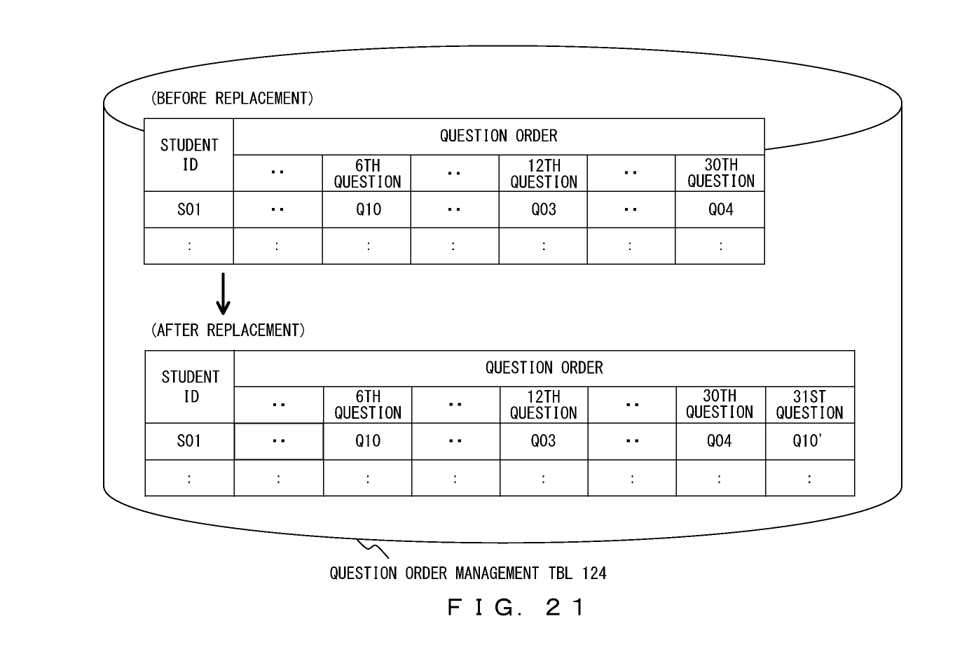

Next, in step S 467, the question correcting unit 118 performs the processing of providing a prescribed instruction to the question order management unit 111 to perform replacement for additional questions for the corrected questions. In the processing, the question correcting unit 118 sends, to the question order management unit 111, the above mentioned prescribed instruction which includes the question ID of the examination question which has been decided to be a bad question. The question order management unit 111 executes the above mentioned processing of step S 305 in FIG. 7 and performs the processing of replacing the question order of the examination question stored in the question order management TBL 124. Explanation is given, by using FIG. 21, for the content of the processing of replacing the question order of the examination questions performed by the question order management unit 111.

The data example of the question order management TBL 124 in FIG. 21 indicates the data example before and after replacement of the question order of the examination questions by the question order management unit 111 on the basis of the instruction from the question correcting unit 118 for the student whose student ID is ‘S01’.

Here, it is defined that the bad-question determining unit 116 has decided that the examination question with the question ID of ‘Q10’ is the bad question and that the information on the question on ‘Q10’ which is the corrected question for ‘Q10’ has already been stored in the question TBL 125. Further, at this time, it is defined that the student with the student ID of ‘S01’ is addressing the 12^{th} question.

First, a question order management unit 111, when receiving the above mentioned prescribed instruction from the question correcting unit 118, refers to the question order management TBL 124 and performs the processing of obtaining the student ID of students to whom the examination questions specified by the question ID included in the instruction have been given. From the data example before replacement of the question order management TBL 124 of FIG. 21, with this processing, the student ID of ‘S01’ to which ‘Q10’ has been already given as the 6^{th} question is obtained. Next, the question order management unit 111 performs the processing of adding the question ID of the corrected question as the examination question of the next question, which is subsequent to the last question, which has already been given for the student specified by the obtained student ID. The data example after replacement of the question order management TBL 124 of FIG. 21 indicates that ‘Q10’ has been added as the 31^{st} question subsequent to the 30^{th} question, which was the last question in the data example before the replacement.

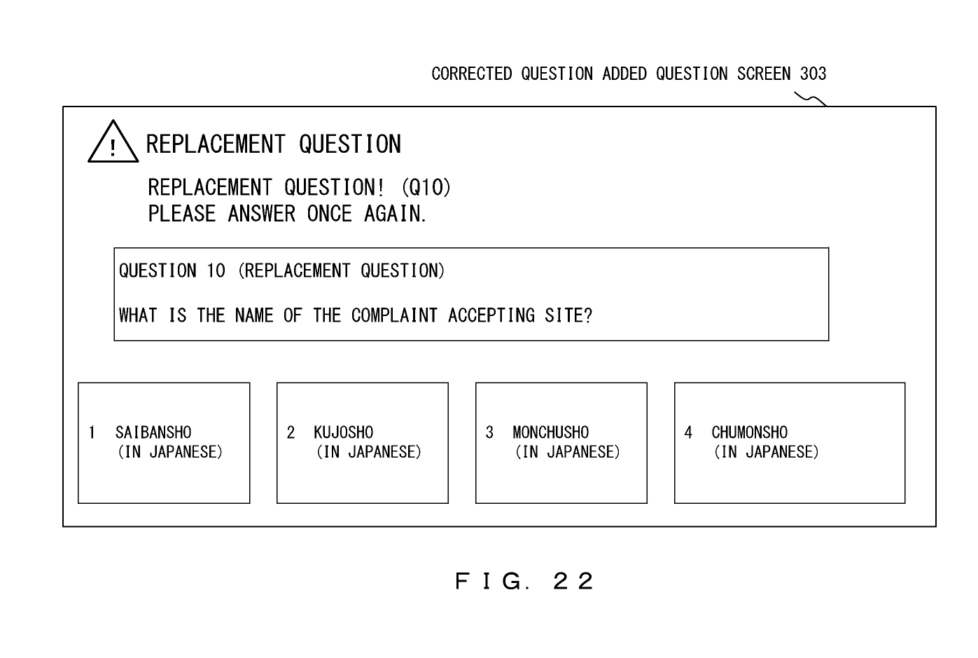

When the corrected questions are added as mentioned so far above, a case occurs in which the result of the determination processing in step S 346 in the question sending processing of FIG. 9 performed by a question sending unit 113 becomes Yes, and then the processing of step S 347 is performed. As mentioned earlier, in step S 347, the question sending unit 113 refers to the question TBL 125 and performs the processing of reading the question data of the corrected questions, editing the examination questions indicated by the question data, and adding the sentence which reports the addition of the corrected question. Then, in the subsequent step S 248, the question sending unit 113 performs the processing of sending the question data which indicates the edited examination questions to the student terminal 200. The screenshot of the corrected-question-added question screen 303, which is the screen displayed on the display unit of the student terminal 200 to which the edited examination questions have been sent, is indicated in FIG. 22.

In the screenshot of the corrected-question-added question screen 303 illustrated in FIG. 22, a sentence informing the students that the corrected questions have been given additionally, in addition to the information display similarly to the normal examination questions.

The question correcting unit 118, after finishing the processing of step S 467 mentioned above, finishes the question correction processing.

Explanation for the question correction processing has been given so far.

As the server device 110, the teacher terminal 150, and the student terminal 200 in FIG. 2 perform each type of control processing, respectively, as explained so far, the examination questions are sent in the different question order for each student terminal 200, and answers of each student are collected.

Then, for the examination questions for which the number of answers has reached a prescribed number, examination questions with a significantly high incorrect-answer ratio are presumed to be inappropriate. Further, in order to quickly decide the correctness or incorrectness for the presumption on the examination question presumed to be a bad question, the examination question is sent to the examinee terminal 2 to which the examination question has not yet been sent, preferentially to other examination questions. Accordingly, it need not take long to presume or decide the bad question.

As mentioned so far above, the examination conducting support system as disclosed herein has an effect of suppressing an elongated time for detecting an inappropriate question.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a indicating of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An examination conducting support device comprising:
a question database in which a plurality of examination questions is stored; and
a processor; wherein
the processor is configured to:
send, to a plurality of examinee terminals operated by each of a plurality of examinees, the plurality of examination questions extracted from the question database, in a different order for each examinee terminal;
obtain answers for the examination questions sent from each of the plurality of examinee terminals;
determine correctness or incorrectness for the obtained answers and calculate an incorrect-answer ratio for each of the plurality of examination questions stored in the question database;
extract, from the plurality of examination questions stored in the question database, an examination question in which the number of obtained answers has reached a prescribed number as a determination target question;
presume whether the determination target question is an inappropriate question, on the basis of an incorrect-answer ratio for the determination target question;
send, when the determination target question is presumed to be an inappropriate question, to an examinee terminal among the plurality of examinee terminals to which the determination target question has not yet been sent, the determination target question preferentially to other examination questions extracted from the question database; and
decide a correctness or incorrectness of the presumption on the determination target question presumed to be an inappropriate question, on the basis of the incorrect-answer ratio for the determination target question after control is performed.

2. The examination conducting support device according to claim 1, wherein the processor
sends, to a prescribed number of examinee terminals, the determination target question in descending order of the number of answers from among the obtained answers in the examinee terminals to which the determination target question presumed to be an inappropriate question has not yet been sent.

3. The examination conducting support device according to claim 1, wherein the processor
registers, in the question database, a corrected question, which is a question obtained by correcting a determination target question decided to be an inappropriate question, and
sets the corrected question as the target for sending, after the corrected question is registered in the question database, instead of the determination target question decided to be an inappropriate question.

4. The examination conducting support device according to claim 3, wherein the processor
sends the corrected question, after the corrected question is registered in the question database, to an examinee terminal to which a determination target question decided to be an inappropariate question has been sent from among the plurality of examinee terminals.

5. The examination conducting support device according to claim 3, wherein the processor
reports a prescribed notice when the determination target question is decided to be an inappropriate question,
obtains a correction instruction for a determination target question decided to be an inappropriate question, the corrected instruction being input in accordance with the prescribed notice, and
registers, in the question database as the corrected question, a question with a correction according to an obtained instruction made to the determination target question decided to be an inappropriate question.

6. The examination conducting support device according to claim 1, further comprising:
a storing unit configured to store a relationship between each of the plurality of examinee terminals and a sending order of an examination question sent by the processor, wherein
the processor specifies an examinee terminal to be sent to when sending the determination target question, on the basis of the relationship which is stored in the storing unit.

7. The examination conducting support device according to claim 1, wherein
the examination question and a correct answer for the examination question are stored, correlated to each examination question, in the question database, and
the processor determines a correctness or incorrectness for an obtained answer on the basis of the correct answer for the examination question stored in the question database.

8. An examination conducting support method comprising:
sending by a processor, to a plurality of examinee terminals operated by each of a plurality of examinees, the plurality of examination questions extracted from the question database in which the plurality of examination questions are stored, in a different order for each examinee terminal;
obtaining, by the processor, an answer for the examination questions sent from each of the plurality of examinee terminals;
determining, by the processor, a correctness or incorrectness for the obtained answer and
calculating, by the processor, an incorrect-answer ratio for each of the plurality of examination questions stored in the question database;
extracting by the processor, from the plurality of examination questions stored in the question database, an examination question in which the number of obtained answers has reached a prescribed number as a determination target question;
presuming, by the processor, whether the determination target question is an inappropriate question, on the basis of an incorrect-answer ratio for the determination target question;
sending by the processor, when the determination target question is presumed to be an inappropriate question, to an examinee terminal among the plurality of examinee terminals to which the determination target question has not yet been sent, the determination target question preferentially to other examination questions extracted from the question database and sent to the examinee terminals; and
deciding, by the processor, a correctness or incorrectness for the presumption of the determination target question presumed to be an inappropriate question, on the basis of the incorrect-answer ratio for the determination target question after sending the determination target question preferentially to the other examination questions.

9. The examination conducting support method according to claim 8, wherein the processor sends the determination target question presumed to be an inappropriate question preferentially to other examination questions comprises sending the determination target question to a prescribed number of examinee terminals in the order starting from the largest number of answers of the obtained answers, among the examinee terminals to which the determination target question has not yet been sent.

10. The examination conducting support method according to claim 8, wherein
in the question database, a corrected question, which is a question obtained by correcting a determination target question decided to be an inappropriate question, and
in sending a plurality of examination questions extracted from the question database to the plurality of examinee terminals, after the corrected question is registered in the question database, the corrected question is given as a target for the sending, instead of the determination target question decided to be an inappropriate question.

11. The examination conducting support method according to claim 10, wherein
in sending a plurality of examination questions extracted from the question database to the plurality of examinee terminals, after the corrected question is registered in the question database, the corrected question is sent to the examinee terminals to which a determination target question decided to be an inappropariate question has already been sent, among the plurality of examinee terminals.

12. The examination conducting support method according to claim 10, wherein
when the determination target question is decided to be an inappropriate question, the processor reports a prescribed notice,
the processor obtains a correction instruction for a determination target question decided to be an inappropriate question, the instruction being made in accordance with the prescribed notice, and
in registering the corrected question, registers, in the question database as the corrected question, a question with a correction according to the obtained correction instruction made to the determination target question decided to be an inappropriate question.

13. The examination conducting support method according to claim 8, wherein
the processor sends the determination target question presumed to be an inappropriate question preferentially to other examination questions comprises specifying an examinee terminal to which the determination target question has not yet been sent, on the basis of a relationship which is stored in the storing unit, the relationship being between each of a plurality of examinee terminals and a sending order of the examination questions sent to the examinee terminal.

14. The examination conducting support method according to claim 8, wherein
the examination question and a correct answer for the examination question are stored in the question database, correlated to each examination question, and
the processor determines a correctness or incorrectness for the obtained answer comprises determining on the basis of a correctness or incorrectness for the examination question stored in the question database.

15. A non-transitory computer-readable recording medium having stored therein a program for causing a computer to execute a process comprising:
sending, to a plurality of examinee terminals operated by each of a plurality of examinees, the plurality of examination questions extracted from the question database in which a plurality of examination questions are stored, in a different order for each examinee terminal;
obtaining an answer for the examination questions sent from each of the plurality of examinee terminals;
determining a correctness or incorrectness for the obtained answer and
calculating an incorrect-answer ratio for each of the plurality of examination questions stored in the question database;
extracting, from the plurality of examination questions stored in the question database, an examination question in which the number of obtained answers has reached a prescribed number as a determination target question;
presuming whether the determination target question is an inappropriate question, on the basis of an incorrect-answer ratio for the determination target question;
sending, when the determination target question is presumed to be an inappropriate question, to an examinee terminal among the plurality of examinee terminals to which the determination target question has not yet been sent, the determination target question preferentially to other examination questions extracted from the question database and sent to the examinee terminals; and
deciding a correctness or incorrectness for the presumption on the determination target question presumed to be an inappropriate question, on the basis of the incorrect-answer ratio for the determination target question after sending the determination target question preferentially to the other examination questions.
